(19) United States
(12) Patent Application Publication
(10) Pub. No.: US 2016/0371426 A1
(43) Pub. Date: Dec. 22, 2016

(54) SYSTEMS AND METHODS FOR PHYSICAL PARAMETER FITTING ON THE BASIS OF MANUAL REVIEW

(71) Applicant: ZYMEWORKS INC., Vancouver (CA)

(72) Inventors: Antonios Samiotakis, New Westminster (CA); Anders Ohrn, Toronto (CA)

(21) Appl. No.: 14/898,930

(22) PCT Filed: Jun. 19, 2014
(86) PCT No.: PCT/CA2014/050577

§ 371 Date: Dec. 16, 2015

Related U.S. Application Data
(60) Provisional application No. 61/861,207, filed on Aug. 1, 2013.
(60) Provisional application No. 61/838,255, filed on Jun. 22, 2013.

(51) Int. Cl. G06F 19/16; G06N 99/00

(52) U.S. Cl. CPC G06F 19/16; G06N 99/005

(57) ABSTRACT

Systems and methods for physical parameter fitting include communicating one or more three-dimensional structures for a molecular system exhibiting a physical parameter value. In response, a dichotomous classification consisting of a first or second indication is received from the user of the disclosed systems and methods. The first and second indications being that the one or more three-dimensional structures are respectively deemed to be in a first or second dichotomous structural class with respect to the physical parameter. The physical parameter value is altered based on the received dichotomous classification. This communicating, receiving, and altering is repeated until an exit condition is deemed to exist.

### TECHNICAL FIELD

The disclosed embodiments relate generally to systems and methods for parameter fitting on the basis of manual review. The disclosed embodiments have wide application in efforts in understanding the physical properties of molecules and, based on this understanding, improving their physical properties.

### BACKGROUND

Many tasks associated with the physical study of molecules such as polymers involve the application of threshold and cut-off parameters. For example, in the process of structural review, a protein engineer may evaluate a crystal structure and search for instances where two or more atoms are in unacceptably close proximity. The definition of unacceptably close inherently involves the setting of a threshold value on the minimum distance between two atoms.

Another example is the case in which an antibody is to be optimized with respect to a physical property of the antibody, such as an antigen binding coefficient, antigen selectivity, or thermostability. Towards this goal, a protein engineer may review a number of structural configurations of the residues of the wild-type antibody as well as mutated versions of the wild-type antibody in order to identify mutations that will improve the physical property. During such structural review, threshold cut-off parameters for many physical parameters such as atomic distances between heavy atoms, dihedral angles, solvent exposed surface area are relied upon for tasks such as including candidate mutations in a further round of optimization, removing such candidate mutations from further consideration, and/or grouping candidate mutations into like groups. For instance, U.S. Provisional Patent Application No. 61/662,549, entitled “Systems and Methods for Identifying Thermodynamically Relevant Polymer Conformations,” describes systems and methods for identifying the thermodynamically relevant configurations of a polymer or polymer region. The methods disclosed in that patent application are highly dependent on manual review of antibody structures by protein engineers.

Other examples include the evaluation of the quality of hydrogen bonds where the distance between the hydrogen bond donor and acceptor atoms, and the donor-hydrogen-acceptor angle are evaluated. These geometric parameters cannot exceed threshold values in order for the arrangement of the donor and acceptor groups to be suitable for hydrogen bond formation.

The structural evaluations referenced above can be performed in an automated fashion with the required threshold values determined from physical theory, or through a statistical analysis of known molecular structures. However, scientist and other workers including physical chemist, structural biologists, crystallographers, and protein engineers, have considerable experience and expertise in evaluating the quality of molecular structures, and do so employing threshold values that cannot be easily derived from first principles theory. The more heuristic structural review performed by these workers can be highly effective in eliminating poor molecular structures, and can serve as a useful complement to methods derived from physical theory and statistical structural analysis.

Polymer optimization processes that make use of domain experts have been described in the literature. For instance, Cooper et al., 2010, “Predicting protein structures with an online multiplayer game,” Nature 466, p. 756, describes the development of a online multiplayer game in which players attempt to lower the free energy of a partially folded/misfolded protein by moving units of secondary structure, or modifying the internal geometry of secondary structure units. Players (domain experts) can also attempt to fold a protein directly from the fully unfolded state. As such, human expertise is used to perform a function that otherwise would be done using fundamental physical theory and large-scale computation. However, the processes described in Cooper have the drawback that threshold values for physical parameter are not acquired from players for subsequent use by an automated system.

Muggleton, 1992, “Protein secondary structure prediction using logic-based machine learning,” Protein Engineering 5, p. 647, describes an automated rule induction system “Golem” that was able to devise a set of rules capable of predicting which residues in a protein sequence will form alpha helices in the folded state. The system was provided with a set of known protein structures and a classification of residues on the basis of their hydrophobicity. However, the reference does not make use of physical parameter thresholds provided by domain experts upon visualization of relevant polymers.

Czibula, 2011, “Solving the Protein Folding Problem Using a Distributed Q-Learning Approach,” International Journal of Computers, 5 (2011) describes a variant of a reinforcement learning approach called Q-learning, and applies this method to the protein folding problem. The basis of the reinforcement learning concept is that automated systems can learn by taking actions to modify the state of a problem domain, receiving a reward/penalty for each action, and then modify their subsequent behavior in order to maximize rewards. In this reference, the actions were moving protein components on a lattice, and the reward/penalties were determined by a change in an energy function. However, the reference does not make use of physical parameter thresholds provided by domain experts upon visualization of relevant polymers.

A drawback with the above-identified pursuits is that the rate-limiting step in molecular studies is often the heuristic structural review performed by workers. Each molecular study is unique, and thus the threshold values used in one study do not necessarily carry over to another study. Thus, the heuristic structural review performed by workers remains a rate-limiting step in such pursuits. Because of this, what are needed in the art are efficient systems and methods for learning the applicable threshold values for a given molecular study from one or more domain experts so that such manual review is made more efficient, and possibly automated.

### SUMMARY

The present disclosure addresses the need in the art. Disclosed are systems and methods for determining the threshold values used by workers in the process of structural review. Once these threshold values have been determined, computational methods making use of the values are employed, and the structural review performed by workers can then be performed automatically and with high fidelity.

In more detail, a value for a physical parameter associated with the molecule is obtained. One or more three-dimensional structures that individually or collectively exhibit the value for the physical parameter is communicated. An indication as to whether the plurality of three-dimensional structures is deemed to exhibit the physical parameter is received. The value for the physical parameter is altered in a manner that is a function of the indication received. This process is repeated until an exit condition is deemed to exist. The exit condition is the first of (i) achievement of a maximum repeat count or (ii) a determination that at least M repeats have occurred in which, in the N most recent instances of receiving an indication, the collective number of indications deeming exhibition of the physical parameter equaled the collective number of indications deeming no exhibition of the physical parameter by the plurality of three-dimensional structures, where M is a first predetermined positive integer, N is a second predetermined positive integer, and N is equal to or less than M.

One aspect of the present disclosure provides a computer-implemented method in which, at a computer system having one or more processors, memory and a display, the following steps are done. A value for a physical parameter associated with a molecule is obtained. One or more three-dimensional structures that individually or collectively exhibit the value for the physical parameter is communicated. An indication as to whether the plurality of three-dimensional structures is deemed to belong to a pre-defined class is received. The value for the physical parameter is altered. These steps of communicating, receiving, and altering are repeated until an exit condition is deemed to exist. The exit condition is the first of (i) achievement of a maximum repeat count or (ii) a determination that at least M repeats of the communicating, receiving, and altering have occurred in which, in the N most recent instances of the receiving, the collective number of indications deeming membership in the class equaled the collective number of indications deeming exclusion from the class of the plurality of three-dimensional structures, where M is a first predetermined positive integer, N is a second predetermined positive integer, and N is equal to or less than M.

After the exit condition is satisfied, the values of the physical parameter exhibited in the final N instances of the communicating are used to compute a single threshold value of the physical parameter.

In some embodiments, the threshold value is the mean, median, maximum, or minimum of the values of the physical parameter exhibited in the final N instances of the communicating.

In some embodiments, the molecule is a protein, the physical parameter is a dihedral angle of a predetermined side chain in the protein, a first structure in the plurality of three-dimensional structures adopts a first dihedral angle for the predetermined side chain, a second structure in the plurality of three-dimensional structures adopts a second dihedral angle for the predetermined side chain, and the first dihedral angle and the second dihedral angle differ from each other by the value for the physical parameter. In some embodiments, the first dihedral angle is obtained from a rotamer library. In some embodiments, the first dihedral angle is obtained from a rotamer library on a deterministic, random or pseudo-random basis.

In some embodiments, the physical parameter is the root mean squared distance between a side chain of a first residue in a first three-dimensional structure in the plurality of three-dimensional structures and the side chain of the first residue in a second three-dimensional structure in the plurality of three-dimensional structures when the first three-dimensional structure is overlayed on the second three-dimensional structure.

In some embodiments, the physical parameter is the root mean squared distance between heavy atoms in a first portion of a first three-dimensional structure in the plurality of three-dimensional structures and the corresponding heavy atoms in the portion of a second three-dimensional structure in the plurality of three-dimensional structures corresponding to the first portion when the first three-dimensional structure is overlayed on the second three-dimensional structure.

In some embodiments, the physical parameter is a distance between a first atom and a second atom in the molecule, where a first three-dimensional structure in the plurality of three-dimensional structures has a first value for this distance and the second three-dimensional structure has a second value for this distance, where the first distance deviates from the second distance by the value for the physical parameter.

In some embodiments, a single structure is communicated, and the physical parameter is a distance between a first atom and a second atom in the structure.

In some embodiments, the receiving indicates if the pair of structures composed of the first three-dimensional structure and the second three-dimensional structure is or is not a member of the class of meaningfully structurally distinct pairs of three dimensional structures. A pair of structures is meaningfully structurally distinct if the user of the systems and methods of the present disclosure deems the two structures of the pair have distinct biological, chemical, biophysical or physical properties.

In some embodiments, the physical parameter is a solvent accessibility, accessible surface area, or solvent-excluded surface of a portion of the molecule, where a first three-dimensional structure in the plurality of three-dimensional structures has a first value for this solvent accessibility, accessible surface area, or solvent-excluded surface and a second three-dimensional structure in the plurality of three-dimensional structures has a second value for solvent accessibility, accessible surface area, or solvent-excluded surface, where the first value for solvent accessibility, accessible surface area, or solvent-excluded surface deviates from the second value for solvent accessibility, accessible surface area, or solvent-excluded surface by the value for the physical parameter.

In some embodiments the receiving indicates if a pair of structures comprising a first three-dimensional structure and a second three-dimensional structure is or is not a member of the class of structure pairs with meaningfully distinct degrees of solvent accessibility, accessible surface area, or solvent-excluded surface. Structure pairs have meaningfully distinct degrees of solvent accessible surface area, accessible surface area, or solvent-excluded surface, when the user of the systems and methods of the present disclosure judge that the difference between the structures in one or more of these quantities is large enough to affect the biological, chemical, biophysical, or physical properties of the molecule.

In some embodiments, the physical parameter is a solvent accessibility, accessible surface area, or solvent-excluded surface of a portion of the molecule, where the plurality of three-dimensional structures communicated consists of a single structure.

In some embodiments the receiving indicates if a particular residue in the single structure communicated belongs or does not belong to the class of buried residues.

In some embodiments altering the value for the physical parameter comprises increasing the value for the physical parameter, when the indication in the previous instance of the receiving is that the plurality of three-dimensional structures is deemed to not belong to the pre-defined class of pluralities of three-dimensional structures, and decreasing the value for the physical parameter, when the indication in the previous instance of the receiving is that the plurality of three-dimensional structures belongs to the pre-defined class. In some embodiments, increasing the value for the physical parameter is accomplished by adjusting the coordinates of one or more atoms in one or more three-dimensional structures in the plurality of three-dimensional structures without human intervention.

In some embodiments adjusting of the coordinates consists of choosing a new rotamer for a residue in the first three-dimensional structure and a new rotamer for a residue in the second three-dimensional structure. In some embodiments the new rotamers are chosen such that the difference between the heavy atom RMSD of the new configuration of the residues, and the heavy atom RMSD of the initial configuration, is equal to a specific value d.

In some embodiments the sign of the value d depends on the indication of class membership supplied in the most recent receiving step.

In some embodiments the value of d is chosen in a deterministic, random, or pseudo-random manner.

In some embodiments the magnitude of the value d is less than 0.1 Å, or equal to 0.1 Å, 0.2 Å, or 0.5 Å, or greater than 0.5 Å.

In some embodiments, the value d is partially or completely determined by the number of repeats of the communicating, receiving, and altering that have occurred.

In some embodiments, increasing the value for the physical parameter is accomplished by substituting in one or more new three-dimensional structures into the plurality of three-dimensional structures. In some embodiments, decreasing the value for the physical parameter is accomplished by adjusting the coordinates of one or more atoms in one or more three-dimensional structures in the plurality of three-dimensional structures without human intervention. In some embodiments, decreasing the value for the physical parameter is accomplished by substituting in one or more new three-dimensional structures into the plurality of three-dimensional structures. In some embodiments, the increasing or the decreasing of the physical parameter is accomplished by removing structures from the plurality of three-dimensional structures.

In some embodiments, the predetermined positive integer M five, six, seven, eight, nine, ten, eleven, twelve, thirteen, fourteen, fifteen, sixteen, seventeen, eighteen, nineteen, or twenty. In some embodiments, the predetermined positive integer M is 10 or greater, 20 or greater, 30 or greater, 40 or greater, 50 or greater, 60 or greater, 70 or greater, 80 or greater, 90 or greater or 100 or greater.

In some embodiments, the predetermined positive integer N is two, four, six, eight, ten, twelve, 14, 16, 18, 20, or some larger even integer.

In some embodiments, the molecule is an amino acid, a polynucleic acid, a polyribonucleic acid, a polysaccharide, or a polypeptide. In some embodiments, the molecule is an organometallic complex, a surfactant, or a fullerene

In some embodiments, the molecule is a protein, the physical parameter is a dihedral angle of a predetermined main chain residue in the protein, a first structure in the plurality of three-dimensional structures adopts a first dihedral angle in the predetermined main chain, a second structure in the plurality of three-dimensional structures adopts a second dihedral angle for the predetermined main chain, and the first dihedral angle and the second dihedral angle differ from each other by the value for the physical parameter. In some embodiments, the dihedral angle is the phi angle, psi angle, or omega angle.

In some embodiments, the physical parameter is a combination of physical parameters.

In some embodiments, the computer-implemented method further comprises storing, responsive to the exit condition, the value or a value range for the physical parameter.

In some embodiments, the plurality of three-dimensional structures consists of two structures, and the two structures collectively exhibit the value for the physical parameter by differing by the value for the physical parameter.

In some embodiments, the plurality of three-dimensional structures is overlayed on each other in the communicating step.

Another aspect of the present disclosure provides a computer-implemented method, comprising, at a computer system having one or more processors, memory and a display, obtaining a value for a physical parameter associated with a molecular system. One or more three-dimensional structures for the molecular system that exhibit the value for the physical parameter are communicated. Responsive to this communication, a dichotomous classification of the one or more three-dimensional structures is received. The dichotomous classification is either a first indication or a second indication. The first indication is that the one or more three-dimensional structures are deemed by a first user to be in a first dichotomous structural class with respect to the physical parameter. The second indication is that the one or more three-dimensional structures are deemed by the first user to be in a second dichotomous structural class, distinct from the first dichotomous structural class, with respect to the physical parameter. The value for the physical parameter is altered as a function of the dichotomous classification that is received. These actions are repeated until an exit condition is deemed to exist. In some embodiments, the exit condition is the first of (i) achievement of a maximum repeat count or (ii) a determination that at least M repeats of the above-identified steps have occurred in which, in the N most recent instances, the collective number of times the received dichotomous classification is the first indication equaled the collective number of times the received dichotomous classification is the second indication, where M is a first predetermined positive integer, N is a second predetermined positive integer, and N is equal to or less than M.

In some embodiments, the molecular system is a protein or protein complex, the physical parameter is a dihedral angle of a predetermined side chain in the molecular system, the one or more three-dimensional structures is a plurality of three-dimensional structures for the molecular system, a first structure in the plurality of three-dimensional structures adopts a first dihedral angle for the predetermined side chain, a second structure in the plurality of three-dimensional structures adopts a second dihedral angle for the predetermined side chain, and the first dihedral angle and the second dihedral angle differ from each other by the value for the physical parameter. In some embodiments, the first dihedral angle is obtained from a rotamer library. In some embodiments, the first dihedral angle is obtained from a rotamer library on a deterministic, random or pseudo-random basis.

In some embodiments, the one or more three-dimensional structures is a plurality of three-dimensional structures, the physical parameter is the root mean squared distance between a side chain of a first residue in a first three-dimensional structure in the plurality of three-dimensional structures and the side chain of the first residue in a second three-dimensional structure in the plurality of three-dimensional structures when the first and second three-dimensional structures are aligned on the coordinates of the backbone atoms and the first three-dimensional structure is overlayed on the second three-dimensional structure.

In some embodiments, the one or more three-dimensional structures is a plurality of three-dimensional structures, the physical parameter is the root mean squared distance between heavy atoms in a first portion of a first three-dimensional structure in the plurality of three-dimensional structures and the corresponding heavy atoms in the portion of a second three-dimensional structure in the plurality of three-dimensional structures corresponding to the first portion when the first three-dimensional structure is overlayed on the second three-dimensional structure.

In some embodiments, the one or more three-dimensional structures comprises a plurality of three-dimensional structures, the dichotomous classification received is the first indication when each member of the plurality of three-dimensional structures is deemed by the first user to be structurally distinct with respect to all other members of the plurality of three-dimensional structures with respect to the physical parameter, and the dichotomous classification received is the second indication when each member of the plurality of three-dimensional structures is deemed by the first user to be structurally indistinct with respect to all other members of the plurality of three-dimensional structures with respect to the physical parameter.

In some embodiments, the one or more three-dimensional structures consist of a single three-dimensional structure. For instance, in some such embodiments, the physical parameter is an interatomic distance between a first atom and a second atom on the molecular system and the value for the physical parameter is a distance between the first atom and the second atom in the molecular system. In another example, in some such embodiments the physical parameter is steric clash, the value for the physical parameter is an interatomic distance, and the dichotomous classification received is the first indication when the single three-dimensional structure is deemed by the first user to exhibit at least one steric clash, and is the second indication when the single three-dimensional structure is deemed by the first user to not exhibit at least one steric clash.

In some embodiments, the physical parameter is a solvent accessibility, accessible surface area, or solvent-excluded surface of a portion of the molecular system, the one or more three-dimensional structures comprises a plurality of three-dimensional structures of the molecular system, a first three-dimensional structure in the plurality of three-dimensional structures has a first value for the physical parameter, a second three-dimensional structure in the plurality of three-dimensional structures has a second value for the physical parameter, and the first value deviates from the second value by the value obtained for the physical parameter in the obtaining or the altering steps. The dichotomous classification received is the first indication when the first value is deemed by the first user to be distinct from the second value with respect to the physical parameter, and the dichotomous classification received is the second indication when the first value is deemed by the first user to not be distinct from the second value with respect to the physical parameter.

In some embodiments, the physical parameter is a solvent accessibility, accessible surface area, or solvent-excluded surface of a portion of the molecule and the one or more three-dimensional structures consists of a single structure. In some such embodiments, the dichotomous classification received in the receiving (C) is the first indication when the first user deems a predetermined portion of the molecular system to be buried in the single structure, and the dichotomous classification received in the receiving (C) is the second indication when the first user deems the predetermined portion of the molecular system to not be buried in the single structure.

In some embodiments, the altering step comprises increasing the value for the physical parameter when the dichotomous classification in the previous instance of the receiving step is the first indication, and decreasing the value for the physical parameter when the dichotomous classification in the previous instance of the receiving step is the second indication. In some embodiments, increasing the value for the physical parameter is accomplished by adjusting the coordinates of one or more atoms in the one or more three-dimensional structures without human intervention. In some embodiments, increasing the value for the physical parameter is accomplished by substituting in one or more new three-dimensional structures into the one or more three-dimensional structures of the molecular system. In some embodiments, decreasing the value for the physical parameter is accomplished by adjusting the coordinates of one or more atoms in the one or more three-dimensional structures without human intervention. In some embodiments, decreasing the value for the physical parameter is accomplished by substituting in one or more new three-dimensional structures into the one or more three-dimensional structures of the molecular system.

In some embodiments, the predetermined positive integer M is set at a value of five or greater. In some embodiments, the predetermined positive integer N is set at a value of M−1. In some embodiments, molecular system is a polynucleic acid, a polyribonucleic acid, a polysaccharide, or a polypeptide. In some embodiments, molecular system is an organometallic complex, a surfactant, or a fullerene. In some embodiments, the molecular system is antigen-antibody complex.

In some embodiments, the molecular system is a protein, the physical parameter is a dihedral angle of a predetermined main chain residue in the protein, the one or more three-dimensional structures is a plurality of three-dimensional structures, a first structure in the plurality of three-dimensional structures adopts a first dihedral angle in the predetermined main chain, a second structure in the plurality of three-dimensional structures adopts a second dihedral angle for the predetermined main chain, the first dihedral angle and the second dihedral angle differ from each other by the value for the physical parameter, the dichotomous classification received in the receiving step is the first indication when the first user deems the first dihedral angle and the second dihedral angle in the respective first and second structures to be structurally distinct, and the dichotomous classification received in the receiving step is the second indication when the first user deems the first dihedral angle and the second dihedral angle in the respective first and second structures to be structurally indistinct. In some embodiments, the dihedral angle is the phi angle, psi angle, or omega angle.

In some embodiments, the physical parameter is a combination of physical parameters.

In some embodiments, the computer-implemented method further comprises storing, responsive to the exit condition, a value or value range for the physical parameter.

In some embodiments, the one or more three-dimensional structures consist of two structures, and the two structures collectively exhibit the value for the physical parameter by differing by the value for the physical parameter.

In some embodiments, the one or more three-dimensional structures comprises a plurality of three-dimensional structures and each respective three-dimensional structure in the plurality of three-dimensional structures is overlayed on a reference three-dimensional structure in the plurality of three-dimensional structures in the communicating step.

In some embodiments, responsive to the exit condition, a value for the physical parameter is stored, where the value is a measure of central tendency of the value used for the physical parameter across the N most recent instances of the communicating step. This measure of central tendency can be, for example, an arithmetic mean, weighted mean, midrange, midhinge, trimean, Winsorized mean, median, or mode of such values.

In some embodiments, the obtaining, communicating, receiving, altering and repeating are repeated, in turn, for each respective user in a plurality of users until the exit condition is achieved for each user in the plurality of users. Then, responsive to the exit conditions, a value for the physical parameter, where the value is a measure of central tendency of the value used for the physical parameter across the N most recent instances of the communicating across each user in the plurality of users. Here as before, the measure of central tendency can be, for example, an arithmetic mean, weighted mean, midrange, midhinge, trimean, Winsorized mean, median, or mode of such values.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings.

FIG. 1 is a block diagram illustrating a system, according to an example.

FIG. 2 illustrates cluster results obtained for each residue i in a polymer by clustering a plurality of structures on a structural characteristic associated with the side chain or the main chain of the i^{th} residue of each respective structure in the plurality of structures in accordance with an example.

FIG. 3 illustrates subgroup results, where each structure in a subgroup falls into the same cluster in a threshold number of the side chain and main chain sets of clusters in a plurality of sets of clusters in accordance with an example.

FIGS. 4A and 4B illustrate a method of identifying thermodynamically relevant conformations for a polymer comprising a plurality of atoms according to an example.

FIG. 5 illustrates a method of identifying polymer structures using simulated annealing according to an example.

FIG. 6 illustrates the identity of each cluster that each side chain of each residue in a plurality of polymer structures falls into and the identity of each cluster that each main chain of each residue in the plurality of polymer structures falls into according to an example.

FIG. 7 is a block diagram illustrating a system, according to one embodiment.

FIG. 8 illustrates a method of identifying a threshold value for a physical parameter of a polymer according to some embodiments.

FIG. 9 illustrates another method of identifying a threshold value for a physical parameter of a polymer according to some embodiments.

Like reference numerals refer to corresponding parts throughout the several views of the drawings.

### DETAILED DESCRIPTION OF THE EMBODIMENTS

The embodiments described herein provide systems and methods evaluating molecular systems.

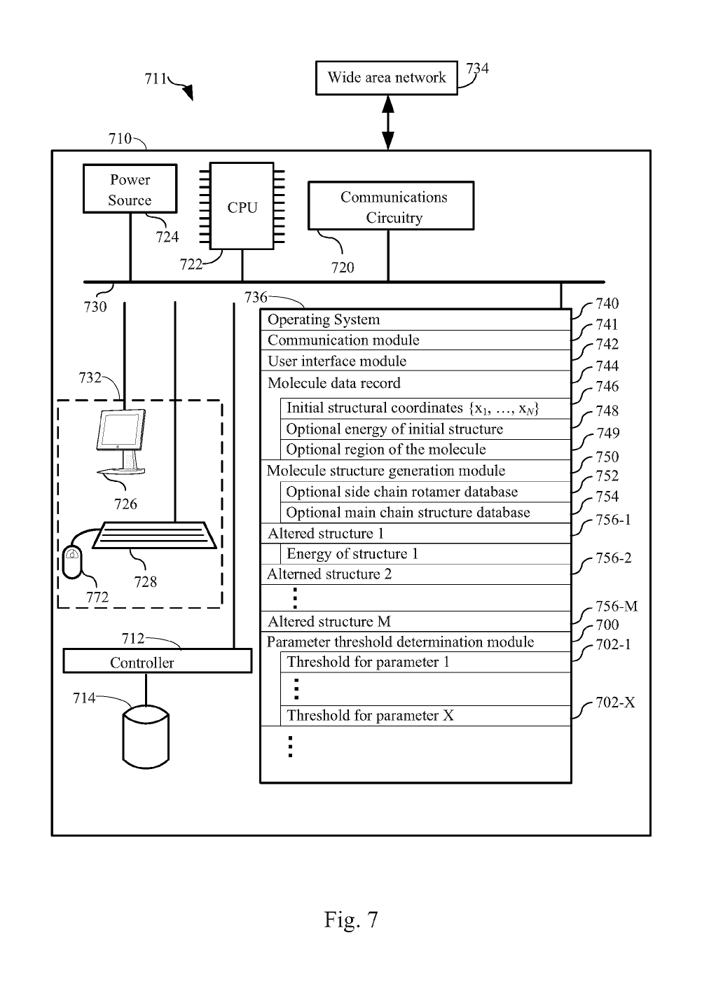

The following provides system and methods that make use of the processes described above for identifying values for physical parameters of molecular systems. FIG. 7 is a block diagram illustrating a computer in accordance with one such embodiment. The computer 10 typically includes one or more processing units (CPU's, sometimes called processors) 722 for executing programs (e.g., programs stored in memory 736), one or more network or other communications interfaces 720, memory 736, a user interface 732, which includes one or more input devices (such as a keyboard 728, mouse 772, touch screen, keypads, etc.) and one or more output devices such as a display device 726, and one or more communication buses 730 for interconnecting these components. The communication buses 730 may include circuitry (sometimes called a chipset) that interconnects and controls communications between system components.

Memory 736 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 736 optionally includes one or more storage devices remotely located from the CPU(s) 722. Memory 736, or alternately the non-volatile memory device(s) within memory 736, comprises a non-transitory computer readable storage medium. In some embodiments, memory 736 or the computer readable storage medium of memory 736 stores the following programs, modules and data structures, or a subset thereof:
an operating system 740 that includes procedures for handling various basic system services and for performing hardware dependent tasks;
an optional communication module 741 that is used for connecting the computer 710 to other computers via the one or more communication interfaces 720 (wired or wireless) and one or more communication networks 734, such as the Internet, other wide area networks, local area networks, metropolitan area networks, and so on;
an optional user interface module 742 that receives commands from the user via the input devices 728, 772, etc. and generates user interface objects in the display device 726;
a molecular system data record 744 that includes (i) initial structural coordinates {x₁, . . . , x_{N}} 746 for the molecular system comprising a plurality of atoms, where the initial structural coordinates {x₁, . . . , x_{N}} comprise coordinates for all or a portion the heavy atoms in the plurality of atoms and may include all or a portion of the hydrogen atoms (if any) in the plurality of atoms, (ii) an optional score 748 of the initial structure, and (iii) an optional identification of a region of the polymer 749;
a molecular system structure generation module 750 that comprises instructions for modifying or adjusting coordinates of the molecular system in order to generate variants of the molecular system that have different three-dimensional coordinates, optionally using a side chain rotamer database 752 and/or a main chain structure database 754 in the case where the molecular system under study is a protein;
a plurality of altered structures 756 for the molecular system, where typically each altered structure 756 has the same atoms as the molecular system under study but has different structural coordinates; and
a parameter threshold determination module 700 for determining physical parameter thresholds 702 for the molecular system under study.

In some embodiments, the molecular system under study is a polymer. In some embodiments this polymer comprises between 2 and 5,000 residues, between 20 and 50,000 residues, more than 30 residues, more than 50 residues, or more than 100 residues. In some embodiments, a residue in the polymer comprises two or more atoms, three or more atoms, four or more atoms, five or more atoms, six or more atoms, seven or more atoms, eight or more atoms, nine or more atoms or ten or more atoms. In some embodiments the polymer 44 has a molecular weight of 100 Daltons or more, 200 Daltons or more, 300 Daltons or more, 500 Daltons or more, 1000 Daltons or more, 5000 Daltons or more, 10,000 Daltons or more, 50,000 Daltons or more or 100,000 Daltons or more.

A polymer, such as those that can be studied using the disclosed systems and methods, is a large molecular system composed of repeating structural units. These repeating structural units are termed particles or residues interchangeably herein. In some embodiments, each particle pᵢ in the set of {p₁, . . . , p_{K}} particles represents a single different residue in the native polymer. To illustrate, consider the case where the native comprises 100 residues. In this instance, the set of {p₁, . . . , p_{K}} comprises 100 particles, with each particle in {p₁, . . . , p_{K}} representing a different one of the 100 particles.

In some embodiments, the polymer that is evaluated using the disclosed systems and methods is a natural material. In some embodiments, the polymer is a synthetic material. In some embodiments, the polymer is an elastomer, shellac, amber, natural or synthetic rubber, cellulose, Bakelite, nylon, polystyrene, polyethylene, polypropylene, or polyacrylonitrile, polyethylene glycol, or polysaccharide.

In some embodiments, the polymer is a heteropolymer (copolymer). A copolymer is a polymer derived from two (or more) monomeric species, as opposed to a homopolymer where only one monomer is used. Copolymerization refers to methods used to chemically synthesize a copolymer. Examples of copolymers include, but are not limited to, ABS plastic, SBR, nitrile rubber, styrene-acrylonitrile, styrene-isoprene-styrene (SIS) and ethylene-vinyl acetate. Since a copolymer consists of at least two types of constituent units (also structural units, or particles), copolymers can be classified based on how these units are arranged along the chain. These include alternating copolymers with regular alternating A and B units. See, for example, Jenkins, 1996, “Glossary of Basic Terms in Polymer Science,” Pure Appl. Chem. 68 (12): 2287-2311, which is hereby incorporated herein by reference in its entirety. Additional examples of copolymers are periodic copolymers with A and B units arranged in a repeating sequence (e.g. (A-B-A-B-B-A-A-A-A-B-B-B)ₙ). Additional examples of copolymers are statistical copolymers in which the sequence of monomer residues in the copolymer follows a statistical rule. If the probability of finding a given type monomer residue at a particular point in the chain is equal to the mole fraction of that monomer residue in the chain, then the polymer may be referred to as a truly random copolymer. See, for example, Painter, 1997, Fundamentals of Polymer Science, CRC Press, 1997, p 14, which is hereby incorporated by reference herein in its entirety. Still other examples of copolymers that may be evaluated using the disclosed systems and methods are block copolymers comprising two or more homopolymer subunits linked by covalent bonds. The union of the homopolymer subunits may require an intermediate non-repeating subunit, known as a junction block. Block copolymers with two or three distinct blocks are called diblock copolymers and triblock copolymers, respectively.

In some embodiments, the polymer is in fact a plurality of polymers, where the respective polymers in the plurality of polymers do not all have the molecular weight. In such embodiments, the polymers in the plurality of polymers fall into a weight range with a corresponding distribution of chain lengths. In some embodiments, the polymer is a branched polymer molecular system comprising a main chain with one or more substituent side chains or branches. Types of branched polymers include, but are not limited to, star polymers, comb polymers, brush polymers, dendronized polymers, ladders, and dendrimers. See, for example, Rubinstein et al., 2003, Polymer physics, Oxford; New York: Oxford University Press. p. 6, which is hereby incorporated by reference herein in its entirety.

In some embodiments, the polymer is a polypeptide. As used herein, the term “polypeptide” means two or more amino acids or residues linked by a peptide bond. The terms “polypeptide” and “protein” are used interchangeably herein and include oligopeptides and peptides. An “amino acid,” “residue” or “peptide” refers to any of the twenty standard structural units of proteins as known in the art, which include imino acids, such as proline and hydroxyproline. The designation of an amino acid isomer may include D, L, R and S. The definition of amino acid includes nonnatural amino acids. Thus, selenocysteine, pyrrolysine, lanthionine, 2-aminoisobutyric acid, gamma-aminobutyric acid, dehydroalanine, ornithine, citrulline and homocysteine are all considered amino acids. Other variants or analogs of the amino acids are known in the art. Thus, a polypeptide may include synthetic peptidomimetic structures such as peptoids. See Simon et al., 1992, Proceedings of the National Academy of Sciences USA, 89, 9367, which is hereby incorporated by reference herein in its entirety. See also Chin et al., 2003, Science 301, 964; and Chin et al., 2003, Chemistry & Biology 10, 511, each of which is incorporated by reference herein in its entirety.

The polypeptides evaluated in accordance with some embodiments of the disclosed systems and methods may also have any number of posttranslational modifications. Thus, a polypeptide includes those that are modified by acylation, alkylation, amidation, biotinylation, formylation, γ-carboxylation, glutamylation, glycosylation, glycylation, hydroxylation, iodination, isoprenylation, lipoylation, cofactor addition (for example, of a heme, flavin, metal, etc.), addition of nucleosides and their derivatives, oxidation, reduction, pegylation, phosphatidylinositol addition, phosphopantetheinylation, phosphorylation, pyroglutamate formation, racemization, addition of amino acids by tRNA (for example, arginylation), sulfation, selenoylation, ISGylation, SUMOylation, ubiquitination, chemical modifications (for example, citrullination and deamidation), and treatment with other enzymes (for example, proteases, phosphotases and kinases). Other types of posttranslational modifications are known in the art and are also included.

In some embodiments, the polymer is an organometallic complex. An organometallic complex is chemical compound containing bonds between carbon and metal. In some instances, organometallic compounds are distinguished by the prefix “organo-” e.g. organopalladium compounds. Examples of such organometallic compounds include all Gilman reagents, which contain lithium and copper. Tetracarbonyl nickel, and ferrocene are examples of organometallic compounds containing transition metals. Other examples include organomagnesium compounds like iodo(methyl)magnesium MeMgI, diethylmagnesium (Et₂Mg), and all Grignard reagents; organolithium compounds such as n-butyllithium (n-BuLi), organozinc compounds such as diethylzinc (Et₂Zn) and chloro(ethoxycarbonylmethyl)zinc (ClZₙCH₂C(═O)OEt); and organocopper compounds such as lithium dimethylcuprate (Li⁺[CuMe₂]⁻). In addition to the traditional metals, lanthanides, actinides, and semimetals, elements such as boron, silicon, arsenic, and selenium are considered form organometallic compounds, e.g. organoborane compounds such as triethylborane (Et₃B).

In some embodiments, the polymer is a surfactant. Surfactants are compounds that lower the surface tension of a liquid, the interfacial tension between two liquids, or that between a liquid and a solid. Surfactants may act as detergents, wetting agents, emulsifiers, foaming agents, and dispersants. Surfactants are usually organic compounds that are amphiphilic, meaning they contain both hydrophobic groups (their tails) and hydrophilic groups (their heads). Therefore, a surfactant molecular system contains both a water insoluble (or oil soluble) component and a water soluble component. Surfactant molecules will diffuse in water and adsorb at interfaces between air and water or at the interface between oil and water, in the case where water is mixed with oil. The insoluble hydrophobic group may extend out of the bulk water phase, into the air or into the oil phase, while the water soluble head group remains in the water phase. This alignment of surfactant molecules at the surface modifies the surface properties of water at the water/air or water/oil interface.

Examples of ionic surfactants include ionic surfactants such as anionic, cationic, or zwitterionic (ampoteric) surfactants. Anionic surfactants include (i) sulfates such as alkyl sulfates (e.g., ammonium lauryl sulfate, sodium lauryl sulfate), alkyl ether sulfates (e.g., sodium laureth sulfate, sodium myreth sulfate), (ii) sulfonates such as docusates (e.g., dioctyl sodium sulfosuccinate), sulfonate fluorosurfactants (e.g., perfluorooctanesulfonate and perfluorobutanesulfonate), and alkyl benzene sulfonates, (iii) phosphates such as alkyl aryl ether phosphate and alkyl ether phosphate, and (iv) carboxylates such as alkyl carboxylates (e.g., fatty acid salts (soaps) and sodium stearate), sodium lauroyl sarcosinate, and carboxylate fluorosurfactants (e.g., perfluorononanoate, perfluorooctanoate, etc.). Cationic surfactants include pH-dependent primary, secondary, or tertiary amines and permanently charged quaternary ammonium cations. Examples of quaternary ammonium cations include alkyltrimethylammonium salts (e.g., cetyl trimethylammonium bromide, cetyl trimethylammonium chloride), cetylpyridinium chloride (CPC), benzalkonium chloride (BAC), benzethonium chloride (BZT), 5-bromo-5-nitro-1,3-dioxane, dimethyldioctadecylammonium chloride, and dioctadecyldimethylammonium bromide (DODAB). Zwitterionic surfactants include sulfonates such as CHAPS (3-[(3-Cholamidopropyl)dimethylammonio]-1-propanesulfonate) and sultaines such as cocamidopropyl hydroxysultaine. Zwitterionic surfactants also include carboxylates and phosphates.

Nonionic surfactants include fatty alcohols such as cetyl alcohol, stearyl alcohol, cetostearyl alcohol, and oleyl alcohol. Nonionic surfactants also include polyoxyethylene glycol alkyl ethers (e.g., octaethylene glycol monododecyl ether, pentaethylene glycol monododecyl ether), polyoxypropylene glycol alkyl ethers, glucoside alkyl ethers (decyl glucoside, lauryl glucoside, octyl glucoside, etc.), polyoxyethylene glycol octylphenol ethers (C₈H₁₇—(C₆H₄)—(O—C₂H₄)₁₋₂₅—OH), polyoxyethylene glycol alkylphenol ethers (C₈H₁₇—(C₆H₄)—(O—C₂H₄)₁₋₂₅—OH), glycerol alkyl esters (e.g., glyceryl laurate), polyoxyethylene glycol sorbitan alkyl esters, sorbitan alkyl esters, cocamide MEA, cocamide DEA, dodecyldimethylamine oxideblock copolymers of polyethylene glycol and polypropylene glycol (poloxamers), and polyethoxylated tallow amine. In some embodiments, the polymer under study is a reverse micelle, or liposome.

In some embodiments, the polymer is a fullerene. A fullerene is any molecular system composed entirely of carbon, in the form of a hollow sphere, ellipsoid or tube. Spherical fullerenes are also called buckyballs, and they resemble the balls used in association football. Cylindrical ones are called carbon nanotubes or buckytubes. Fullerenes are similar in structure to graphite, which is composed of stacked graphene sheets of linked hexagonal rings; but they may also contain pentagonal (or sometimes heptagonal) rings.

In some embodiments, the set of M three-dimensional coordinates {x₁, . . . , x_{M}} for the polymer are obtained by x-ray crystallography, nuclear magnetic resonance spectroscopic techniques, or electron microscopy. In some embodiments, the set of M three-dimensional coordinates {x₁, . . . , x_{M}} is obtained by modeling (e.g., molecular dynamics simulations).

In some embodiments, the polymer includes two different types of polymers, such as a nucleic acid bound to a polypeptide. In some embodiments, the polymer includes two polypeptides bound to each other. In some embodiments, the polymer under study includes one or more metal ions (e.g. a metalloproteinase with one or more zinc atoms) and/or is bound to one or more organic small molecules (e.g., an inhibitor). In such instances, the metal ions and or the organic small molecules may be represented as one or more additional particles pᵢ in the set of {p₁, . . . , p_{K}} particles representing the native polymer.

In some embodiments, the programs or modules identified in FIG. 7 correspond to sets of instructions for performing a function described above. The sets of instructions can be executed by one or more processors (e.g., the CPUs 722). The above identified modules or programs (e.g., sets of instructions) need not be implemented as separate software programs, procedures or modules, and thus various subsets of these programs or modules may be combined or otherwise re-arranged in various embodiments. In some embodiments, memory 736 stores a subset of the modules and data structures identified above. Furthermore, memory 736 may store additional modules and data structures not described above.

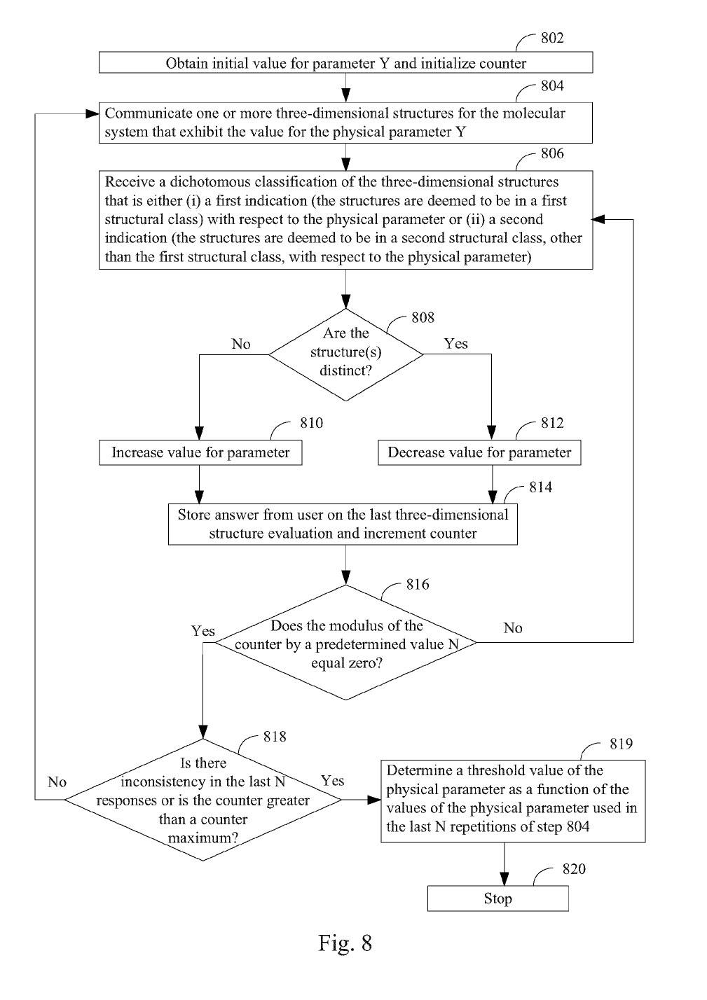

Now that a system in accordance with the systems and methods of the present disclosure has been described, attention turns to FIG. 8 which illustrates an exemplary method in accordance with the present disclosure.

Step 802.

In step 802, an initial value for a parameter Y is obtained and a counter is initialized to zero. In some embodiments the parameter is a dihedral angle. In an example where the molecular system under study is a protein, the parameter could be a dihedral angle of a predetermined side chain in the protein.

In some embodiments, the physical parameter is the root mean squared distance between a side chain of a first residue in a first three-dimensional structure of a molecular system under study and the side chain of the first residue in a second three-dimensional structure of the molecular system under study when the first three-dimensional structure is overlayed on the second three-dimensional structure.

In some embodiments, the physical parameter is the root mean squared distance between heavy atoms (e.g., non-hydrogen atoms) in a first portion of a first three-dimensional structure of the molecular system under study and the corresponding heavy atoms in the portion of a second three-dimensional structure of the molecular system corresponding to the first portion when the first three-dimensional structure is overlayed on the second three-dimensional structure.

In some embodiments, the physical parameter is a distance between a first atom and a second atom in the molecular system, where a first three-dimensional structure of the molecular system has a first value for this distance and a second three-dimensional structure of the molecular system has a second value for this distance, such that the first distance deviates from the second distance by the initial value.

In some embodiments, the physical parameter is a solvent accessibility, accessible surface area, or solvent-excluded surface of a portion of the molecular system, where a first three-dimensional structure of the molecular system under study has a first value for this solvent accessibility, accessible surface area, or solvent-excluded surface and the second three-dimensional structure of the molecular system under study has a second value for this solvent accessibility, accessible surface area, or solvent-excluded surface, where the first value for solvent accessibility, accessible surface area, or solvent-excluded surface deviates from the second value for solvent accessibility, accessible surface area, or solvent-excluded surface by the value of the parameter. In some embodiments accessible surface area (ASA), also known as the “accessible surface”, is the surface area of a molecular system that is accessible to a solvent. Measurement of ASA is usually described in units of square Angstroms. ASA is described in Lee & Richards, 1971, J. Mol. Biol. 55(3), 379-400, which is hereby incorporated by reference herein in its entirety. ASA can be calculated, for example, using the “rolling ball” algorithm developed by Shrake & Rupley, 1973, J. Mol. Biol. 79(2): 351-371, which is hereby incorporated by reference herein in its entirety. This algorithm uses a sphere (of solvent) of a particular radius to “probe” the surface of the molecular system. Solvent-excluded surface, also known as the molecular surface or Connolly surface, can be viewed as a cavity in bulk solvent (effectively the inverse of the solvent-accessible surface). It can be calculated in practice via a rolling-ball algorithm developed by Richards, 1977, Annu Rev Biophys Bioeng 6, 151-176 and implemented three-dimensionally by Connolly, 1992, J. Mol. Graphics 11(2), 139-141, each of which is hereby incorporated by reference herein in its entirety.

Step 804.

In step 804, one or more three-dimensional structures for the molecular system under study that exhibit the value for the physical parameter Y are communicated.

For example, in one embodiment of step 804, a pair of three-dimensional structures of the molecular system under study, which differ by a designated value for parameter Y, is displayed. Initially, this designated value is the initial value from step 802. In instances where step 804 is repeated, this designated value is updated.

In one embodiment, the molecular system is a protein, the physical parameter is a dihedral angle of a predetermined side chain in the protein, a first structure of the molecular system that is communicated adopts a first dihedral angle for the predetermined side chain, a second structure for the molecular system that is communicated adopts a second dihedral angle for the predetermined side chain, and the first dihedral angle and the second dihedral angle differ from each other by the value of the parameter received in step 802. In some embodiments, the first dihedral angle is obtained from a rotamer library, such as optional side chain rotamer database 752 or optional main chain structure database 754. Examples of such databases are found in, for example, Shapovalov and Dunbrack, 2011, “A smoothed backbone-dependent rotamer library for proteins derived from adaptive kernel density estimates and regressions,” Structure 19, 844-858; and Dunbrack and Karplus, 1993, “Backbone-dependent rotamer library for proteins. Application to side chain prediction,” J. Mol. Biol. 230: 543-574, Lovell et al., 2000, “The Penultimate Rotamer Library,” Proteins: Structure Function and Genetics 40: 389-408, each of which is hereby incorporated by reference herein in its entirety. In some embodiments, the optional side chain rotamer database 752 comprises those referenced in Xiang, 2001, “Extending the Accuracy Limits of Prediction for Side-chain Conformations,” Journal of Molecular Biology 311, p. 421, which is hereby incorporated by reference in its entirety. In some embodiments, the first dihedral angle is obtained from a rotamer library on a deterministic, random or pseudo-random basis.

In another example, the molecular system under study is a protein, the physical parameter is a dihedral angle of a predetermined main chain residue in the protein, the first structure adopts a first dihedral angle in the predetermined main chain, the second structure adopts a second dihedral angle for the predetermined main chain, and the first dihedral angle and the second dihedral angle differ from each other by the value of the parameter received in step 802.

In some embodiments the displaying that occurs in step 804 displays a pair of three-dimensional structures on display 726. In some embodiments the display 726 emits a three-dimensional image. In other embodiments, three-dimensional structures are vectorized or rasterized and viewed in two-dimensions with the ability to rotate the structures based on user input. In some embodiments the displaying that occurs in step 804 involves sending one or more three-dimensional structures to a client device (not shown in FIG. 7) across wide area network 734 (the Internet) where they are viewed remotely. In some embodiments the one or more structures comprises a plurality of structures that are superimposed on each other and displayed in that fashion. For example, in the case where the molecular system of interest is a protein, the structures can be superimposed on each other by any number of well known means including for example, the techniques disclosed in Cohen, 1997, “ALIGN: a program to superimpose protein coordinates, accounting for insertions and deletions” J. Appl. Cryst. 30, 1160-1161, which is hereby incorporated by reference herein in its entirety.

In some embodiments, step 804 communicates a plurality of structures of the molecular system under study and these structures are displayed adjacent to each other. In some embodiments, step 804 involves communicating of a plurality of structures of the molecular system under study that are displayed sequentially.

Step 806.

In step 806, an indication is received as to whether the one or more structures is deemed by the user to be a member of the class of pairs of meaningfully structurally distinct three-dimensional structures, with respect to the current value of the physical parameter. Typically the answer is either affirmative, indicating that the pair of structures is structurally distinct with respect to the current value of the physical parameter, or negative, indicating that the pair of structures is not structurally distinct with respect to the current value of the physical parameter. In some embodiments all indications in recurring instances of step 806 are from a single user. In some embodiments indications in recurring instances of step 806 are from a community of users. In some embodiments indications in recurring instances of step 806 are from a community of users and the response of some users are up-weighted relative to other users based on factors such as user reliability or user experience.

In some embodiments, step 806 comprises receiving, responsive to the communicating step 804, a dichotomous classification of the one or more three-dimensional structures. This dichotomous classification is either a first indication or a second indication. The first indication means that the one or more three-dimensional structures are deemed by a first user to be in a first dichotomous structural class with respect to the physical parameter. The second indication means that the one or more three-dimensional structures are deemed by the first user to be in a second dichotomous structural class, distinct from the first dichotomous structural class, with respect to the physical parameter.

To illustrate, consider the use case in which the physical parameter is a solvent accessibility, accessible surface area, or solvent-excluded surface of a portion of the molecular system and the one or more three-dimensional structures comprises a plurality of three-dimensional structures of the molecular system. A first three-dimensional structure in the plurality of three-dimensional structures has a first value for the physical parameter. A second three-dimensional structure in the plurality of three-dimensional structures has a second value for the physical parameter. The first value deviates from the second value by the value for the physical parameter obtained in step 802. In this use case scenario, the dichotomous classification received in step 806 is the first indication when the first value is deemed by the first user to be distinct from the second value with respect to the physical parameter. The dichotomous classification received in step 806 is the second indication when the first value is deemed by the first user to not be distinct from the second value with respect to the physical parameter.

Steps 808-812.

In steps 808 through 812, a determination is made as to whether to alter the current value for the physical parameter under study. In the embodiment illustrated in FIG. 8, this is done by increasing or decreasing the value for the parameter under study based on the indication received in step 806. That is, the value for the parameter is increased (810) when the indication received in step 806 was negative (808—No), indicating that the one or more structures communicated in the last instance of step 804 was not a member of the class of meaningfully distinct structures with respect to the current value of the physical parameter. And the value for the parameter is decreased (812) when the indication received in step 806 was positive (808—No), indicating that the one or more structures communicated in the last instance of step 804 was a member of the class of meaningfully structurally distinct pairs of structures with respect to the current value of the physical parameter.

To illustrate, consider the use case presented above in conjunction with step 806 in which the one or more three-dimensional structures comprises a plurality of three-dimensional structures of the molecular system. A first three-dimensional structure in the plurality of three-dimensional structures has a first value for the physical parameter. A second three-dimensional structure in the plurality of three-dimensional structures has a second value for the physical parameter. The first value deviates from the second value by the value for the physical parameter obtained in step 802. In this use case scenario, the dichotomous classification received in step 806 is the first indication (808—Yes) when the first value is deemed by the first user to be distinct from the second value with respect to the physical parameter. In this instance, the value for the physical parameter is decreased (812). The dichotomous classification received in step 806 is the second indication (808—No) when the first value is deemed by the first user to not be distinct from the second value with respect to the physical parameter. In this instance, the value for the physical parameter is increased (810).

In some embodiments, increasing the current value for the physical parameter (808—No, 810) is accomplished by adjusting the coordinates of one or more atoms in the first three-dimensional structure or the second three-dimensional structure of the pair of structures displayed in the last instance of step 804 without human intervention.

In some embodiments, increasing the current value for the physical parameter (808—No, 810) is accomplished by selecting a new first three-dimensional structure or a new three-dimensional structure for the molecular system under study. In such embodiments, this new three-dimensional structure replaces one of the structures displayed in the last instance of step 804. In some such embodiments, more than one of the one or more three-dimensional structures of the molecular system under study that were displayed in the last instance of step 804 is replaced in this procedure.

In some embodiments, decreasing the current value for the physical parameter (808—Yes, 812) is accomplished by adjusting the coordinates of one or more atoms in the first three-dimensional structure or the second three-dimensional structure of the pair of structures displayed in the last instance of step 804 without human intervention.

In some embodiments, decreasing the current value for the physical parameter (808—Yes, 812) is accomplished by selecting a new first three-dimensional structure or a new three-dimensional structure for the molecular system. In such embodiments, this new three-dimensional structure replaces one of the structures displayed in the last instance of step 804. In some such embodiments, both three-dimensional structures of the molecular system under study that were displayed in the last instance of step 804 are replaced.

In some embodiments, the current value for the physical parameter under study is adjusted on a random or pseudo-random basis rather than undergoing steps 808 through 812. In still other embodiments, the current value for the physical parameter under study is adjusted on a determined basis (e.g., stepped through a series of predetermined values or predetermined increments in successive iterations of loop 804-816) rather than undergoing steps 808 through 812.

Step 814.

In step 814 the answer from the last instance of step 806 is recorded. Such recordation involves book keeping to record the user's class indication (e.g., whether or not a pair of structures are distinct as a function of the value of the physical parameter used in step 804). For example, consider the case where the physical parameter under study is the heavy atom RMSD between two different conformations of the same residue side chain in a protein under study. In this example, one of the structures displayed in step 804 has the residue side chain in one conformation, and the other structure displayed in step 804 has the residue displayed in a second conformation. What is sought then, is the exact threshold or threshold range (in terms of the heavy atom RMSD between the two side chain conformations) where the user does not reliably designate the two side chain poses as being in the class of meaningfully structurally distinct pairs of residue conformations. At values of the RMSD greater than this threshold value, the user judges the pair of side chain conformations to belong to the class of meaningfully structural distinct pairs of residue conformations. At RMSD values less than this threshold, the user deems the pair of residue conformations contained in the structures displayed in step 804 does not belong to the class of meaningfully structurally distinct pairs of residue conformations. For example, the side chain could be the side chain of an arginine residue with sequence ID 100 in the molecular system. This side chain is displayed in one conformation in one of the structures displayed in step 804, and the side chain is displayed in a different conformation in the other structure displayed in step 804. The two structures displayed in step 804 are identical in all aspects other than the conformation of the side chain of residue 100. Furthermore, the structures displayed in 804 are displayed after being aligned on all backbone heavy atoms, and the two structures are displayed with one structure overlaid on the other. In this example, step 814 would record the side chain heavy atom RMSD between the two conformations of residue 100 displayed in step 804. Further, step 814 would record whether the user deemed the pair of side chain conformations of residue 100 in the two structures displayed in step 804 to belong to the class of meaningfully structurally distinct pairs of side chain conformations.

Step 816.

In order to assess whether the user's indications received in instances of step 806 are internally consistent with each other it is necessary to repeat steps 804 through 814 a number of times and then evaluate the responses as a function of the values for the physical parameter under study. In typical embodiments, this number of times is predetermined. In some embodiments, loop 804-816 of FIG. 8 is repeated is five, six, seven, eight, nine, ten, eleven, twelve, thirteen, fourteen, fifteen, sixteen, seventeen, eighteen, nineteen, or twenty times. In some embodiments, loop 804-816 of FIG. 8 is repeated 10 times or greater, 20 times or greater, 30 times or greater, 40 times or greater, 50 times or greater, 60 times or greater, 70 times or greater, 80 times or greater, 90 times or greater or 100 times or greater.

There is any number of ways of determining whether to repeat loop 804-816 a predetermined number of times. In some embodiments, each time loop 804-816 is repeated, a counter that was initialized in step 802 is advanced. For instance, this counter could be advanced in each instance of step 814. In some embodiments of step 816, the modulus of the value of this counter is taken against the predetermined number and, if the modulus is other than zero, loop 804-816 is repeated. For instance, if the predetermined number is 5 but the counter is at 2 (meaning the this is the second instance of loop 804-816, the modulus is 2 (2 modulo 5), and so the condition that the modulus of the counter by the predetermined value N being equal to zero fails (816—No) and loop 804-816 is repeated. In another example, consider the case where the predetermined number is 5 and the counter is at 5 (meaning the this is the fifth instance of loop 804-816, the modulus is 0 (5 modulo 5), and so the condition that the modulus of the counter by the predetermined value N being equal to zero is satisfied (816—Yes) and process control passes to step 818.

Step 818.

In step 818, a determination is made as to whether the results from the last N responses are internally consistent. In some embodiments, N is the repeat count used in step 816 to trigger an exit from loop 804-816. In some embodiments, N is the total number of times loop 804-816 has been executed.

In some embodiments, what is sought is a threshold value for the physical parameter that delineates between the various molecular structures of the molecular system of interest displayed in successive instances of step 804. For example, structures that exhibit a meaningful difference in the parameter under study greater than this threshold value are reliably designated as members of the class of meaningfully distinct pairs of structures. Structure pairs that have a difference in the parameter under study less than this threshold value are reliably designated as excluded from the class of meaningfully distinct pairs of structures.

In some embodiments, what is sought is a threshold value range for the parameter that delineates between the various structures of the molecular system of interest displayed in successive instances of step 804. For example, structure pairs that have a difference in the parameter under study greater than this threshold value range are reliably designated being members the class of strongly structurally distinct pairs of structures. Structure pairs that have a difference in the parameter under study less than this threshold value range are reliably designated as being members of the class of structurally indistinct pairs of structures. Structure pairs that have a difference in the parameter under study in this threshold value range are reliably designated as being members of the class of weakly structurally distinct pairs of structures. The nature of the terms “strongly” and “weakly” reflect the subjective judgments of the user whose judgment is being sought using the systems and methods disclosed herein.

In step 818, a determination is made as to whether this desired threshold value or threshold value range has been determined by evaluating whether the user responses recorded in step 814 are internally inconsistent. For instance in three different pairs of structures of the molecular system, the user designated a respective difference in a parameter under study of 10 Angstroms to signify membership in the class of meaningfully structurally distinct structure pairs, 9 Angstroms to signify exclusion from the class of meaningfully structurally distinct structure pairs, and 8 Angstroms to signify membership in the class of meaningfully structurally distinct structure pairs. If there is no inconsistency (818—No), process control returns to step 804 to begin another series of loop 804-816. If there is inconsistency (818—Yes) the process proceeds to step 819.

In some embodiments, even if there is no inconsistency detected, the loop ends (818—Yes) when a maximum repeat count (i.e., a maximum number of times step 818 is to be executed) occurs. In some embodiments, this maximum repeat count is three, four five, six, seven, eight, nine, ten, eleven, twelve, thirteen, fourteen, fifteen, sixteen, seventeen, eighteen, nineteen, or twenty.

Step 819.

In step 819, the threshold value of the physical parameter is determined as a function of the values of the physical parameter used in the N repetitions of step 804 that preceded satisfaction of the termination condition in step 818. For example, a threshold value of the side chain heavy atom RMSD, could be determined by taking a measure of central tendency (e.g., arithmetic mean, weighted mean, midrange, midhinge, trimean, Winsorized mean, median, mode) of the set of side chain RMSD values used in the final N repetitions of step 804.

Step 820.

In step 820, the process illustrated in FIG. 8 ends.

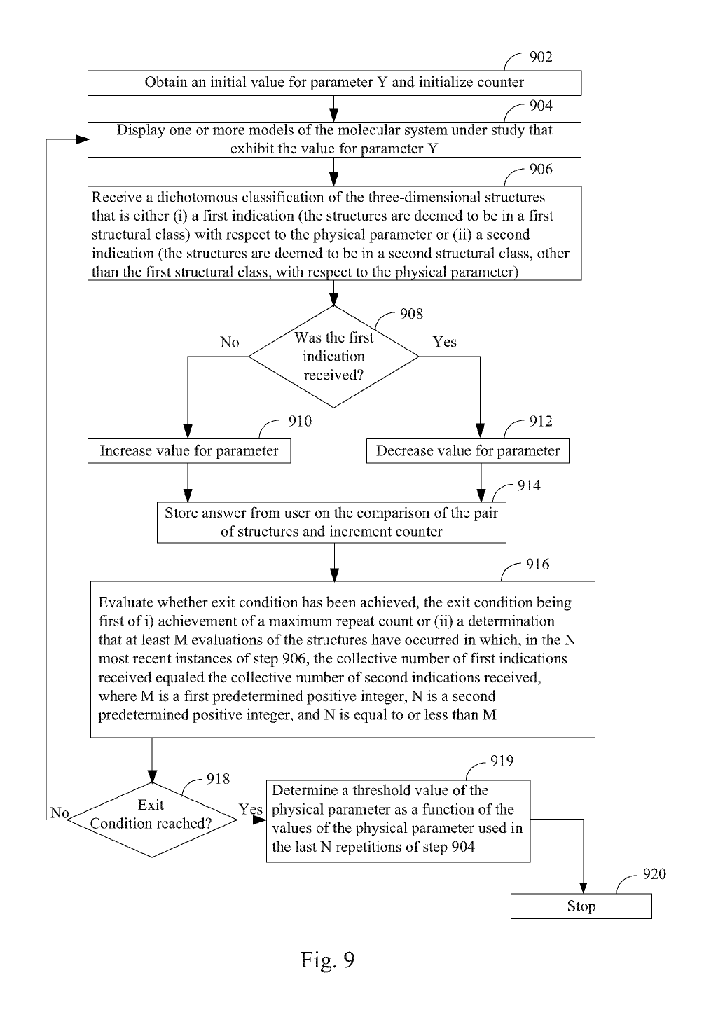

FIG. 9 illustrates another embodiment of the present disclosure.

Step 902.

In step 902 an initial value for a parameter Y is obtained and a counter initialized as described above with respect to step 802 of FIG. 8.

Step 904.

In step 904 a one or more structures of the molecular system under study are displayed that exhibit the value for physical parameter Y. The value and the number of structures displayed will depend on the nature of the physical parameter. For instance, in the case where the physical parameter is solvent accessibility, only a single structure is needed and the query to the user whether a predetermined portion of the single structure is solvent accessible or not. In another example, in the case where the physical parameter is steric clash, only a single structure is needed and the query to the user whether the structure exhibits a steric clash or not. In the case of rotamer angles, two structures that include a side-chain having a rotamer angle that deviates by the initial value are displayed and the query to the user is whether this deviation in rotamer value is significant or not. Thus, in some embodiments, the one or more structures is a plurality of structures that collectively exhibit a difference in the value of the physical parameter under study and the object of step 906 is to determine whether a domain expert believes that the plurality of structures fall into a first dichotomous structural class with respect to the physical parameter or into a second dichotomous structural class with respect to the physical parameter.

Step 906.

In step 906, an indication is received as whether the one or more structures belong to the first or the second dichotomous structural class with respect to the physical parameter. For instance, in some embodiments a pair of structures is exhibited step 904 and what is determined in step 906 is whether a user considers the pair of models to be a member of the class that exhibit structurally distinct three-dimensional structures, with respect to the current value of the physical parameter. Typically the answer is either affirmative, indicating that the pair of structures is structurally distinct with respect to the current value of the physical parameter, or negative, indicating that the pair of structures is not structurally distinct with respect to the current value of the physical parameter. In some embodiments all indications in recurring instances of step 906 are from a single user. In some embodiments indications in recurring instances of step 906 are from a community of users. In some embodiments indications in recurring instances of step 906 are from a community of users and the response of some users are up-weighted relative to other users based on factors such as user reliability or user experience.

In some embodiments, step 906 comprises receiving, responsive to the communicating step 904, a dichotomous classification of the one or more three-dimensional structures. This dichotomous classification is either a first indication or a second indication. The first indication means that the one or more three-dimensional structures are deemed by a first user to be in a first dichotomous structural class with respect to the physical parameter. The second indication means that the one or more three-dimensional structures are deemed by the first user to be in a second dichotomous structural class, distinct from the first dichotomous structural class, with respect to the physical parameter.

To illustrate, consider the use case in which the physical parameter is a solvent accessibility, accessible surface area, or solvent-excluded surface of a portion of the molecular system and the one or more three-dimensional structures comprises a plurality of three-dimensional structures of the molecular system. A first three-dimensional structure in the plurality of three-dimensional structures has a first value for the physical parameter. A second three-dimensional structure in the plurality of three-dimensional structures has a second value for the physical parameter. The first value deviates from the second value by the value for the physical parameter obtained in step 902. In this use case scenario, the dichotomous classification received in step 906 is the first indication when the first value is deemed by the first user to be distinct from the second value with respect to the physical parameter. The dichotomous classification received in step 906 is the second indication when the first value is deemed by the first user to not be distinct from the second value with respect to the physical parameter.

Steps 908-912.

In steps 908 through 912, a determination is made as to whether to alter the current value for the physical parameter under study. In the embodiment illustrated in FIG. 9, this is done by increasing or decreasing the value for the parameter under study based on the indication received in step 906. That is, the value for the parameter is increased (910) when the indication received in step 906 was negative (908—No), indicating that the one or more structures communicated in the last instance of step 904 were not a member of the class of meaningfully distinct structures with respect to the current value of the physical parameter. And the value for the parameter is decreased (912) when the indication received in step 906 was positive (908—Yes), indicating that the one or more structures communicated in the last instance of step 904 were a member of the class of meaningfully structurally distinct pairs of structures with respect to the current value of the physical parameter.

To illustrate, consider the use case presented above in conjunction with step 906 in which the one or more three-dimensional structures comprises a plurality of three-dimensional structures of the molecular system. A first three-dimensional structure in the plurality of three-dimensional structures has a first value for the physical parameter. A second three-dimensional structure in the plurality of three-dimensional structures has a second value for the physical parameter. The first value deviates from the second value by the value for the physical parameter obtained in step 902. In this use case scenario, the dichotomous classification received in step 906 is the first indication (908—Yes) when the first value is deemed by the first user to be distinct from the second value with respect to the physical parameter. In this instance, the value for the physical parameter is decreased (912). The dichotomous classification received in step 906 is the second indication (908—No) when the first value is deemed by the first user to not be distinct from the second value with respect to the physical parameter. In this instance, the value for the physical parameter is increased (910).

In some embodiments, increasing the current value for the physical parameter (908—No, 910) is accomplished by adjusting the coordinates of one or more atoms in the first three-dimensional structure or the second three-dimensional structure of the pair of structures displayed in the last instance of step 904 without human intervention.

In some embodiments, increasing the current value for the physical parameter (908—No, 910) is accomplished by selecting a new first three-dimensional structure or a new three-dimensional structure for the molecular system under study. In such embodiments, this new three-dimensional structure replaces one of the structures displayed in the last instance of step 904. In some such embodiments, more than one of the one or more three-dimensional structures of the molecular system under study that were displayed in the last instance of step 904 is replaced in this procedure.

In some embodiments, decreasing the current value for the physical parameter (908—Yes, 912) is accomplished by adjusting the coordinates of one or more atoms in the first three-dimensional structure or the second three-dimensional structure of the pair of structures displayed in the last instance of step 904 without human intervention.

In some embodiments, decreasing the current value for the physical parameter (908—Yes, 912) is accomplished by selecting a new first three-dimensional structure or a new three-dimensional structure for the molecular system. In such embodiments, this new three-dimensional structure replaces one of the structures displayed in the last instance of step 904. In some such embodiments, both three-dimensional structures of the molecular system under study that were displayed in the last instance of step 904 are replaced.

In some embodiments, the current value for the physical parameter under study is adjusted on a random or pseudo-random basis rather than undergoing steps 908 through 912. In still other embodiments, the current value for the physical parameter under study is adjusted on a determined basis (e.g., stepped through a series of predetermined values or predetermined increments in successive iterations of loop 904-916) rather than undergoing steps 908 through 912.

Step 914.

In step 914 the answer from the last instance of step 906 is recorded. Such recordation involves book keeping to record the user's class indication (e.g., whether or not a pair of structures are distinct as a function of the value of the physical parameter used in step 904). For example, consider the case where the physical parameter under study is the heavy atom RMSD between two different conformations of the same residue side chain in a protein under study. In this example, one of the structures displayed in step 904 has the residue side chain in one conformation, and the other structure displayed in step 904 has the residue displayed in a second conformation. What is sought then, is the exact threshold or threshold range (in terms of the heavy atom RMSD between the two side chain conformations) where the user does not reliably designate the two side chain poses as being in the class of meaningfully structurally distinct pairs of residue conformations. At values of the RMSD greater than this threshold value, the user judges the pair of side chain conformations to belong to the class of meaningfully structural distinct pairs of residue conformations. At RMSD values less than this threshold, the user deems the pair of residue conformations contained in the structures displayed in step 904 does not belong to the class of meaningfully structurally distinct pairs of residue conformations. For example, the side chain could be the side chain of an arginine residue with sequence ID 100 in the molecular system. This side chain is displayed in one conformation in one of the structures displayed in step 904, and the side chain is displayed in a different conformation in the other structure displayed in step 904. The two structures displayed in step 904 are identical in all aspects other than the conformation of the side chain of residue 100. Furthermore, the structures displayed in 904 are displayed after being aligned on all backbone heavy atoms, and the two structures are displayed with one structure overlaid on the other. In this example, step 914 would record the side chain heavy atom RMSD between the two conformations of residue 100 displayed in step 904. Further, step 914 would record whether the user deemed the pair of side chain conformations of residue 100 in the two structures displayed in step 904 to belong to the class of meaningfully structurally distinct pairs of side chain conformations.

Steps 916-918.

In order to assess whether the user's indications received in instances of step 906 are internally consistent with each other it is necessary to repeat steps 904 through 914 a number of times (each time incrementing the counter) and then evaluate the responses as a function of the values for the physical parameter under study. In some embodiments this is accomplished by repeating loop 904-918-No until an exit condition is deemed to exist (918—Yes). In some embodiments, the exit condition is the first of (i) achievement of a maximum repeat count or (ii) a determination that at least M repeats have occurred in which, in the N most recent instances, the collective number of times the received dichotomous classification is the first indication equaled the collective number of times the received dichotomous classification is the second indication, where M is a first predetermined positive integer, N is a second predetermined positive integer, and N is equal to or less than M. For instance, in some embodiments the exit condition is the first of i) achievement of a maximum repeat count or (ii) a determination that at least M evaluations of the structures have occurred in which, in the N most recent instances of step 906, the collective number of indications deeming exhibition of the physical parameter equaled the collective number of indications deeming no exhibition of the physical parameter by the one or more models, where M is a first predetermined positive integer, N is a second predetermined positive integer, and N is equal to or less than M.

In some embodiments, what is sought by imposing the exit condition is a threshold value for the physical parameter that delineates between the various molecular structures of the molecular system of interest displayed in successive instances of step 904. For example, structures that exhibit a meaningful difference in the parameter under study greater than this threshold value are reliably designated as members of the class of meaningfully distinct pairs of structures. Structure pairs that have a difference in the parameter under study less than this threshold value are reliably designated as excluded from the class of meaningfully distinct pairs of structures.

In some embodiments, what is sought is a threshold value range for the parameter that delineates between the various structures of the molecular system of interest displayed in successive instances of step 904. For example, structure pairs that have a difference in the parameter under study greater than this threshold value range are reliably designated being members the class of strongly structurally distinct pairs of structures. Structure pairs that have a difference in the parameter under study less than this threshold value range are reliably designated as being members of the class of structurally indistinct pairs of structures. Structure pairs that have a difference in the parameter under study in this threshold value range are reliably designated as being members of the class of weakly structurally distinct pairs of structures. The nature of the terms “strongly” and “weakly” reflect the subjective judgments of the user whose judgment is being sought using the systems and methods disclosed herein.

A check for the exit condition provides for a way to determine whether a desired threshold value or threshold value range has been determined for the physical parameter by evaluating whether the user responses recorded in step 914 are internally inconsistent. For instance in three different pairs of structures of the molecular system, the user designated a respective difference in a parameter under study of 10 Angstroms to signify membership in the class of meaningfully structurally distinct structure pairs, 9 Angstroms to signify exclusion from the class of meaningfully structurally distinct structure pairs, and 8 Angstroms to signify membership in the class of meaningfully structurally distinct structure pairs.

In some embodiments, even if there is no inconsistency detected, the exit condition is arises when a maximum repeat count (e.g., a maximum number of times step 918 is to be executed) occurs. In some embodiments, this maximum repeat count is three, four five, six, seven, eight, nine, ten, eleven, twelve, thirteen, fourteen, fifteen, sixteen, seventeen, eighteen, nineteen, or twenty.

Step 918.

In step 918, process control returns to step 904 if the exit condition has not been achieved (918—No) and advances to step 919 if it has been achieved.

Step 919.

In step 919, the threshold value of the physical parameter is determined as a function of the values of the physical parameter used in the N repetitions of step 904 that preceded satisfaction of the termination condition in step 918. For example, a threshold value of the side chain heavy atom RMSD, could be determined by taking a measure of central tendency (e.g., arithmetic mean, weighted mean, midrange, midhinge, trimean, Winsorized mean, median, mode) of the set of side chain RMSD values used in the final N repetitions of step 904.

Step 920.

In step 920 the process illustrated in FIG. 9 ends.

### Example 1

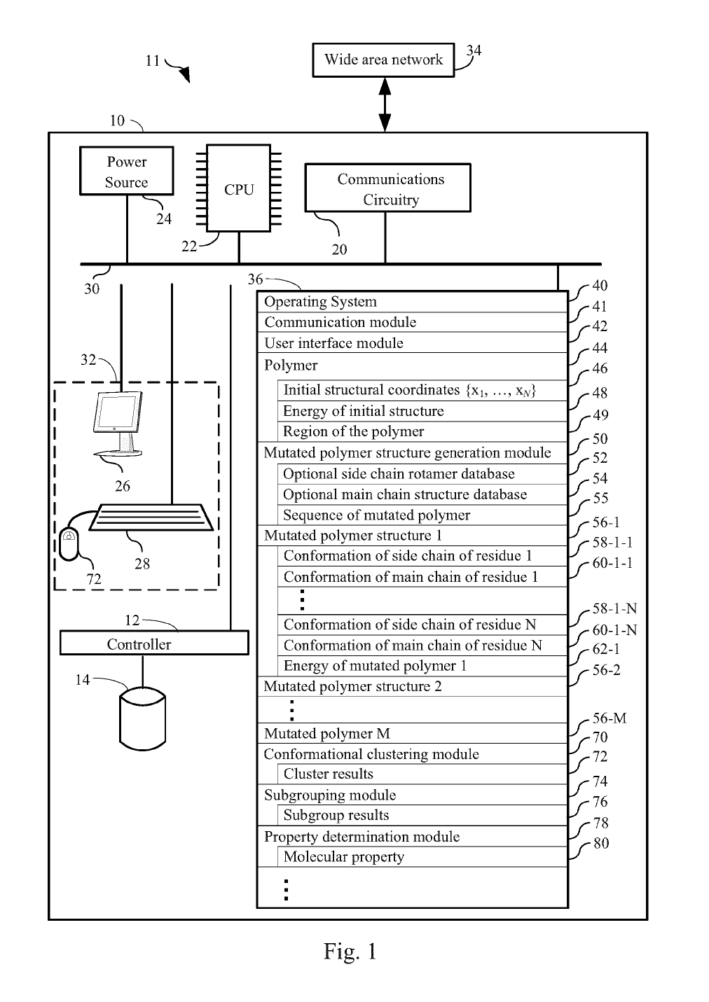

The following provides and example of a system and method that makes use of the processes described above for identifying threshold values for physical parameters of molecules. FIG. 1 is a block diagram illustrating a computer according to this example. The computer 10 typically includes one or more processing units (CPU's, sometimes called processors) 22 for executing programs (e.g., programs stored in memory 36), one or more network or other communications interfaces 20, memory 36, a user interface 32, which includes one or more input devices (such as a keyboard 28, mouse 72, touch screen, keypads, etc.) and one or more output devices such as a display device 26, and one or more communication buses 30 for interconnecting these components. The communication buses 30 may include circuitry (sometimes called a chipset) that interconnects and controls communications between system components.

Memory 36 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 36 optionally includes one or more storage devices remotely located from the CPU(s) 22. Memory 36, or alternately the non-volatile memory device(s) within memory 36, comprises a non-transitory computer readable storage medium. In some instance of this example, memory 36 or the computer readable storage medium of memory 36 stores the following programs, modules and data structures, or a subset thereof:
an operating system 40 that includes procedures for handling various basic system services and for performing hardware dependent tasks;
an optional communication module 41 that is used for connecting the computer 10 to other computers via the one or more communication interfaces 20 (wired or wireless) and one or more communication networks 34, such as the Internet, other wide area networks, local area networks, metropolitan area networks, and so on;
an optional user interface module 42 that receives commands from the user via the input devices 28, 72, etc. and generates user interface objects in the display device 26;
a polymer data record 44 that includes (i) initial structural coordinates {x₁, . . . , x_{N}} 46 for the polymer comprising a plurality of atoms, where the initial structural coordinates {x₁, . . . , x_{N}} comprise coordinates for all or a portion the heavy atoms in the plurality of atoms and may include all or a portion of the hydrogen atoms in the plurality of atoms, (ii) a score 48 of the initial structure, and (iii) an identification of a region of the polymer 49;
a mutated polymer structure generation module 50 that comprises instructions for replacing, in silico, the side chain or main chain of one or more residues of the polymer 44 in the region of the polymer 49 with different conformations, optionally using a side chain rotamer database 52 and/or an optional main chain structure database 54; the mutated polymer structure generation module 50 further including the primary sequence of the mutated polymer 55 which consists of the polymer 44 in which one or more residues have been substituted, where a mutation is understood to include the identity mutation (which keeps the type of a residue constant, but may alter the coordinates of the atoms comprising the residue);
a plurality of mutated polymer structures 56, each mutated polymer structure 56 having the primary sequence of mutated polymer 55 and each mutated polymer structure being generated by the mutated polymer structure generation module 50;
a conformational clustering module 70 that comprises instructions, for each respective residue i in the polymer 44, of (i) clustering the plurality of mutated structures 56 based on a structural characteristic associated with the side chain of the i^{th} residue of each respective structure in the plurality of structures, thereby deriving a set of side chain clusters for the respective i^{th} residue, (ii) optionally, clustering the plurality of mutated polymer structures 56 based on a structural characteristic associated with the main chain of the i^{th} residue of each respective structure in the plurality of structures, thereby deriving a set of main chain clusters for the i^{th} residue, thereby deriving cluster results 72 and (iii) in place of (ii) optionally clustering the plurality of mutated polymer structures 56 based on a structural characteristic associated with the main chain coordinates of a contiguous main chain segment in the plurality of mutated polymer structures 56;
a subgrouping module 74 for grouping respective structures in the plurality of structures into a plurality of subgroups, where each structure in a subgroup in the plurality of subgroups falls into the same cluster in a threshold number of the side chain and main chain sets of clusters in the plurality of sets of clusters in cluster results 72; and
a property determination module 78 for determining a molecular (e.g., thermodynamic) property of a plurality of mutated polymer structures 56 in all or a portion of the subgroups in the subgroup results 76, thereby identifying a thermodynamically relevant polymer conformation for the polymer 46.

In some instance of this example, the polymer 44 comprises between 2 and 5,000 residues, between 20 and 50,000 residues, more than 30 residues, more than 50 residues, or more than 100 residues. In some instance of this example, a residue in the polymer comprises two or more atoms, three or more atoms, four or more atoms, five or more atoms, six or more atoms, seven or more atoms, eight or more atoms, nine or more atoms or ten or more atoms. In some instance of this example the polymer 44 has a molecular weight of 100 Daltons or more, 200 Daltons or more, 300 Daltons or more, 500 Daltons or more, 1000 Daltons or more, 5000 Daltons or more, 10,000 Daltons or more, 50,000 Daltons or more or 100,000 Daltons or more.

In some instances of this example, the programs or modules identified above correspond to sets of instructions for performing a function described above. The sets of instructions can be executed by one or more processors (e.g., the CPUs 22). The above identified modules or programs (e.g., sets of instructions) need not be implemented as separate software programs, procedures or modules, and thus various subsets of these programs or modules may be combined or otherwise re-arranged in various instance of this example. In some instance of this example, memory 36 stores a subset of the modules and data structures identified above. Furthermore, memory 36 may store additional modules and data structures not described above.

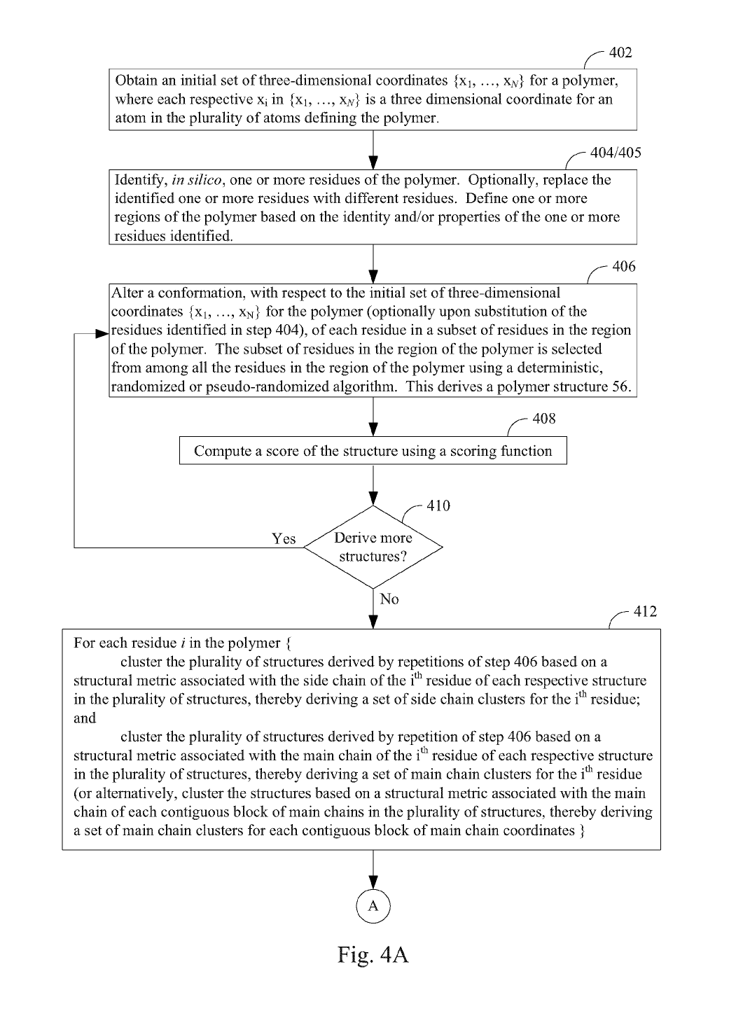

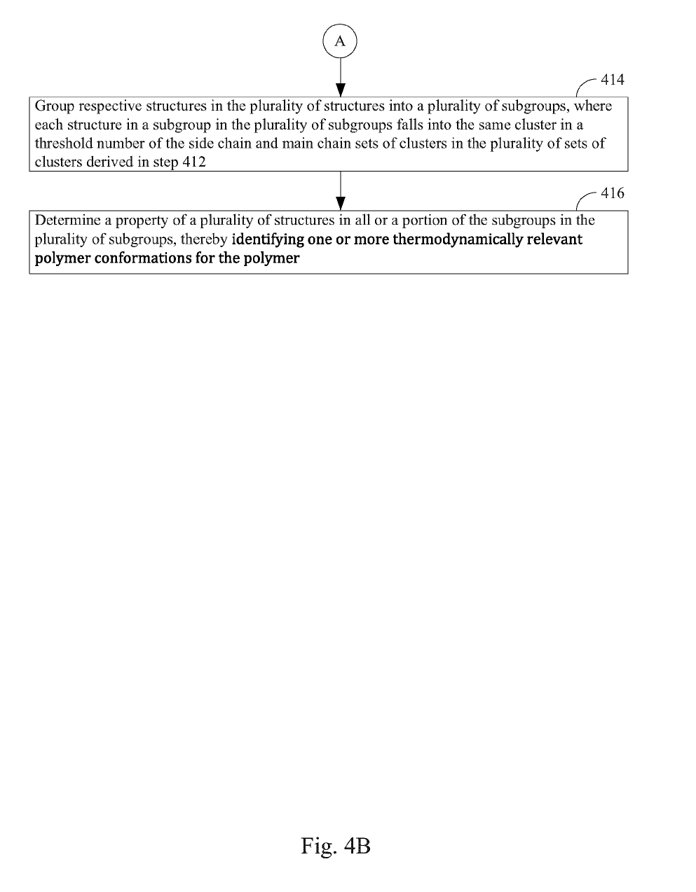

Now that a system in accordance with the this example has been described, attention turns to FIG. 4 which illustrates a method in accordance with this example.

Step 402.

In step 402, an initial set of three-dimensional coordinates {x₁, . . . , x_{N}} 46 is obtained for a polymer 44. In one use case, the polymer 44 is a polynucleic acid and each coordinate xᵢ in the set {x₁, . . . , x_{N}} is that of a heavy atom (i.e., any atom other than hydrogen) in the polynucleic acid. In another use case, the polymer 44 is a polyribonucleic acid and each coordinate xᵢ in the set {x₁, . . . , x_{N}} is that of a heavy atom in the polyribonucleic acid. In still another use case, the polymer 44 is a polysaccharide and each coordinate xᵢ in the set {x₁, . . . , x_{N}} is that of a heavy atom in the polysaccharide. In still another use case, the polymer 44 is a protein and each coordinate xᵢ in the set of {x₁, . . . , x_{N}} coordinates is that of a heavy atom in the protein. The set {x₁, . . . , x_{N}} may further include the coordinates of hydrogen atoms in the polymer 44.

In some instances, the initial structural coordinates {x₁, . . . , x_{N}} 46 for the complex molecule of interest are obtained by x-ray crystallography, nuclear magnetic resonance spectroscopic techniques, or electron microscopy. In some instances, the initial set of three-dimensional coordinates {x₁, . . . , x_{N}} 46 is obtained by modeling (e.g., molecular dynamics simulations). In typical instances, each coordinate in {x₁, . . . , x_{N}} is a coordinate in three dimensional space (e.g., x, y z).

In some instances, there are ten or more, twenty or more, thirty or more, fifty or more, one hundred or more, between one hundred and one thousand, or less than 500 residues in the polymer 44.

Steps 404 and 405.

In step 404, a residue of the polymer 44 in a region of the polymer is identified, in silico, and is optionally replaced with a different residue. In fact, in step 404, more than one residue in a region of the polymer can be identified. In practice, one or more residues of the polymer 44 are identified in the initial structural coordinates {x₁, . . . , x_{N}} 46. The identified one or more residues are either replaced with different residues and/or they are not replaced and the wild type identity of the residues is maintained. In step 405, one or more regions of the polymer are defined based on the identity and/or properties of the residues identified in step 404.

In some instances, a single residue of the polymer 44 is identified, and optionally replaced with a different residue and the region of the polymer is defined as a sphere having a predetermined radius, where the sphere is centered either on a particular atom of the identified residue (e.g., Cₐ carbon in the case of proteins) or the center of mass of the identified residue. In some instances, the predetermined radius is five Angstroms or more, 10 Angstroms or more, or 20 Angstroms or more. For example, in some instances, the polymer 44 is a protein comprising 200 residues and an alanine at position 100 (i.e., the 100^{th} residues of the 200 residue protein) that is found in the polymer 44 is changed to a tyrosine (i.e., A100W). Then, the region of polymer 49 is defined based on the position of A100W. In some instances, the region of the polymer is the Cₐₗₚₕₐ carbon or a designated main chain atom of residue 100 either before or after the side chain has been replaced.

In some instances, more than two residues are identified and the region of the polymer 49 in fact is more than two regions. For example, in some instances, the polymer is a protein, two different residues are identified, and the region of the polymer 49 comprises (i) a first sphere having a predetermined radius that is centered on the Cₐₗₚₕₐ carbon of the first identified residue and (ii) a second sphere having a predetermined radius that is centered on the Cₐₗₚₕₐ carbon of the second identified residue. Depending on how close the two substitutions are, the residues may or may not overlap. In alternative instances, more than two residues are identified, and optionally mutated, and the region is a single contiguous region.

In some instances, each residue in a plurality of residues of the polymer 44 is identified in step 404. In some instances, this plurality of residues consists of two residues. In some instances, this plurality of residues consists of three residues. In some instances, this plurality of residues consists of four residues. In some instances, this plurality of residues consists of five residues. In some instances, this plurality of residues comprises more than five residues. There is no requirement that the plurality of residues be contiguous within the polymer 44. In some instances, each respective residue in the plurality of residues is replaced with a different residue. In some instances, some of the residues in the plurality of residues are replaced with different residues. In some instances, none of the residues in the plurality of residues are replaced with different residues. In some of the foregoing instances, the region of the polymer 49 is a single region that is defined as a sphere having a predetermined radius, where the sphere is centered at a center of mass of the plurality of identified residues either before or after optional substitution. In some instances, the predetermined radius is five Angstroms or more, 10 Angstroms or more, or 20 Angstroms or more. For example, consider the case where the polymer 44 is a protein comprising 200 residues and an alanine at position 100 (i.e., the 100^{th} residue of the 200 residue protein) that is found in the polymer 44 is changed to a tyrosine (i.e., A100W) and a leucine at position 102 of the polymer 44 is changed to an isoleucine (i.e., L102I). Then, the region of polymer 49 is defined based on the positions of A100W and L102I. In some instances, the region of the polymer is the center of mass of A100W and L102I either before or after the mutations have been made.

Step 406.

Step 404 defines a primary sequence of a mutated polymer 55. Throughout this example it will be appreciated that the mutated polymer 55 may in fact have the sequence of the un-mutated polymer 44 because the term “mutated” includes the null mutation where an identified residue is not mutated. The remainder of the steps disclosed in FIG. 4 are designed to identify one or more physical properties of the polymer 55 based on a plurality of three dimensional physical models of the mutated polymer. A three dimensional physical model of the mutated polymer is referred to herein as a mutated polymer structure 56.

The initial structural coordinates {x₁, . . . , x_{N}}, altered, when applicable, to include the side chains of the mutated polymer 55, is the starting point for obtaining the mutated polymer structures 56. An alteration of the conformation, with respect to the starting point structure, of each residue in a subset of residues in the region 49 of the polymer is made. The subset of residues in the region 49 of the polymer is selected from among all the residues in the region 49 of the polymer using a deterministic, randomized or pseudo-randomized algorithm, thereby deriving a structure of the region of the polymer 49.

As one example, consider the case in which the polymer 44 is a protein comprising 200 residues and an alanine at position 100 (i.e., the 100^{th} residue of the 200 residue protein) that is found in the polymer 44 is changed to a tyrosine (i.e., A100W). In this example, the region 49 of polymer is defined as those residues that have at least one atom that is within 20 Angstroms of the Cₐₗₚₕₐ carbon of the tyrosine after the A100W substitution. In step 406, one or more residues among those residues that have at least one atom that is within 20 Angstroms of the Cₐₗₚₕₐ carbon of the tyrosine after the A100W substitution is selected for alteration.

In some instances, one residue is selected for side-chain conformational alteration from within the region 49 of the polymer in an instance of step 406. In some instances, two residues are selected for side-chain conformational alternation from within the region 49 of the polymer in an instance of step 406. In some instances, three residues are selected for side-chain conformational alternation from within the region 49 of the polymer in an instance of step 406. In some instances, four residues are selected for side-chain conformational alternation from within the region 49 of the polymer in an instance of step 406. In some instances, five residues are selected for side-chain conformational alternation from within the region 49 of the polymer in an instance of step 406. In some instances, six, seven, eight, nine, or ten residues are selected for side-chain conformational alternation from within the region 49 of the polymer in an instance of step 406. In some instances, more than ten residues is selected for side-chain conformational alternation from within the region 49 of the polymer in an instance of step 406. In some instances, the number and identity of residues that are selected for alteration is determined on a random or pseudo-random basis.

In some instances, the conformation of a single residue is altered in step 406. In some instances, the conformation of the single residue is altered by either replacing the single residue with the coordinates of a different amino acid type or by leaving the amino acid type of the single residue intact but altering the coordinates of the single residue. The identity of the single residue that is altered in such instances can be selected in a random, pseudo-random or deterministic manner.

In some instances, step 406 is performed by mutated polymer structure generation module 50.

In some instances, the subset of residues that is selected for substitution from within the region 49 of the polymer is done on a deterministic, randomized or pseudo-randomized basis. In some instances, the side chain of each residue in the subset of residues that is selected for alteration is altered to a new rotamer. In some instances, the new rotamer is selected from a side chain rotamer database (library) 52. Rotamers are usually defined as low energy side chain conformations. The use of optional side chain rotamer database 52 allows for the sampling of the most likely side chain conformations, saving time and producing a structure that is more likely to have lower energy. See, for example, Shapovalov and Dunbrack, 2011, “A smoothed backbone-dependent rotamer library for proteins derived from adaptive kernel density estimates and regressions,” Structure 19, 844-858; and Dunbrack and Karplus, 1993, “Backbone-dependent rotamer library for proteins. Application to side chain prediction,” J. Mol. Biol. 230: 543-574, Lovell et al., 2000, “The Penultimate Rotamer Library,” Proteins: Structure Function and Genetics 40: 389-408, each of which is hereby incorporated by reference herein in its entirety. In some instances, the optional side chain rotamer database 52 comprises those referenced in Xiang, 2001, “Extending the Accuracy Limits of Prediction for Side-chain Conformations,” Journal of Molecular Biology 311, p. 421, which is hereby incorporated by reference in its entirety.

In some instances, dead end elimination principals are used to reject certain conformations in an instance of step 406. In one use case, a first rotamer for a given side chain of a residue in the polymer is eliminated if any alternative rotamer for the given side chain of the residue in the polymer contributes less to the total energy of the polymer than the first rotamer. In some instances, this form of dead end elimination principle is used in addition to a Monte Carlo based simulated annealing process to select rotamers for use. Dead end elimination principles are disclosed in Desmet et al., 1992, “The dead-end elimination theorem and its use in protein side-chain position”, Nature 356: 539-542; Goldstein, 1994, “Efficient rotamer elimination applied to protein side chains and related spin glasses”, Biophys. J. 66: 1335-1340; and Lasters et al., 1995, “Enhanced dead-end elimination in the search for the global minimum energy conformation of a collection of protein side chains”, Protein Eng. 8: 815-822; and Leach and Lemon, 1998, “Exploring the Conformational Space of Protein Side Chains Using Dead-End Elimination and the A* Algorithm”, Proteins: Structure, Function, and Genetics 33: 227-239 (1998), each of which is hereby incorporated by reference in its entirety.

In some instances, the main chain alteration is selected from a main chain structure database 54. In some instances the main chain conformation is not altered in step 406.

In another use case in accordance with step 406, the search for conformations is coupled with the optimization of side chain degrees of freedom, and makes use of a side chain rotamer database 52. In this use case, step 406 is performed by sequentially optimizing each residue in the region 49 of the polymer. Specifically, for a respective residue i in the region 49 of the polymer, the coordinates of the rotamer for the residue type of residue i in the rotamer database 52 is applied to the side chain of residue i in a coordinate set for the polymer. In some instances, the coordinate set to which this rotamer is applied is the initial coordinate set 46 or a set of coordinates 56 from a previous iteration of steps 406 through 412. In other instances, the coordinate set to which this rotamer is applied is the initial coordinate set 46 after the side chains of some of the residues in the region 49 of the polymer have been set to random conformations. In still other instances, the coordinate set to which this rotamer is applied is the initial coordinate set 46 after the side chains of all of the residues in the region 49 of the polymer have been set to random conformations. The main chain coordinates of residue i are held fixed when the rotamer is applied. This rotamer application results in the alteration of the side chain coordinates for residue i in the coordinate set and thus a new conformation in the region 49 of the polymer. In the process of applying the rotamer to residue i, the conformations of the other residues in the region 49 of the polymer are held fixed. In some instances, this process of application of the rotamer to a respective residue i to the applicable coordinate set 46 is repeated for each rotamer for the residue type of residue i in the rotamer database 52 thereby resulting in a plurality of coordinates sets for the polymer 44, each coordinate set representing a different rotamer for residue i. To illustrate the example, consider the case in which the residue type of residue i is threonine and the rotamer database 52 in use has three rotamers for threonine, termed the p (χᵢ=59), t (χ₁=−171), and m (χ₁=−61) rotamers. In this illustration, three copies of the starting molecular structure are made. The p rotamer is applied to residue i of the first copy of the starting molecular structure, resulting in a first polymer structure 56. The t rotamer is applied to residue i of the second copy of the starting molecular structure, resulting in a second polymer structure 56. The m rotamer is applied to residue i of the third copy of the starting molecular structure, resulting in a third polymer structure 56.

Step 408.

In step 408 a score of a mutated polymer structure 56 constructed in step 406 is calculated using a scoring function. If the step 406 created several mutated polymer structures 56, each of the structures is scored. The score can be computed using any one of several possible functions. As an exemplary use case, process control can loop over every respective atom in the mutated polymer structure 56 and compute, for example, the coulomb interaction and/or van der Waals interaction between the respective atom and every other atom in the structure, with the interaction between any two atoms being only computed once in preferred instances. As a matter of practice, in some instances the all-atom potential (force field) developed for use in the AMBER molecular dynamics package, or variants thereof, is used in some instances to compute the score of the mutated polymer structure. See for example, Cornell et al., 1995, “A Second Generation Force Field for the Simulation of Proteins,” Nucleic Acids, and Organic Molecules”, J. Am. Chem. Soc. 117: 5179-5197, which is hereby incorporated by reference herein in its entirety. However, the variety of scoring functions that can be employed in step 408 is large. For example, a statistical potential that returns a value based only on the relative distances between a subset of the atoms on each residue in the mutated polymer structure 56 can be used. This could be supplemented with a potential that returns a value based on the relative spatial orientation of the residues. As such, there are a considerable number of possible scoring functions all of which are within the scope of the present disclosure. Moreover, while in some instances the scoring function provides a score in terms of an “energy”, the score returned by a scoring function need not correspond directly to a physical quantity.

In instances where step 406 generated a plurality of polymer structures, each respective polymer structure in the plurality of polymer structures being for a corresponding rotamer of a given residue i, each such polymer structure is scored and the side chain coordinates for the rotamer of residue i that are associated with the most favorable score are identified. The coordinates of the polymer structure containing this most favorable rotamer are retained as a possible thermodynamically relevant alternative conformation of the polymer.

Step 410.

In step 410, a determination is made as to whether to derive more mutated polymer structures 56 having the sequence of mutated polymer 55. Moreover, in some instances, when a decision is made to derive another mutated polymer structure 56 (410—Yes), a further decision is made as to which set of coordinates to use as the starting set of coordinates for this mutated polymer structure 56. These options include using the coordinates of the mutated polymer structure 56 generated in any of the previous instances of step 406 or the initial structural coordinates 46.

In some instances in which step 406 was used to generate a plurality of polymer structures, each respective polymer structure in the plurality of polymer structures being for a corresponding rotamer of a residue i, a decision is made to derive another mutated polymer structure 56 (410—Yes) for the next residue (i+1) in the region 49 of the polymer. In some instances, the starting point structure that is used for the optimization of residue i+1 are the coordinates of the mutated polymer containing the most favorable rotamer for residue i. Subsequently, in another instance of step 408, the coordinates of the polymer structure containing the most favorable rotamer at position (i+1) are retained as a possible thermodynamically relevant alternative conformation of the polymer. In this manner, steps 406 and 408 are performed for each residue in the region 49 of the polymer until all residues have been tested. Each n^{th} instance of steps 406 and 408, in such instances, uses the most favorable coordinates from the (n−1)^{th} instance of steps 406 and 408. The order in which residues in the region 49 of the polymer are selected for such rotamer analysis with steps 406 and 408 is chosen at random prior to optimizing any residue. Once all residues in the region 49 of the polymer have been optimized by steps 406 and 408, a new random ordering of the residues is generated, and the procedure of sequentially polling each rotamer position of each residue in region 49 of the polymer is repeated. The sequential optimization terminates when rotamer re-optimization of all residues in the polymer region does not result in a change in the rotamer conformation of any side chain. The last conformation of the polymer region is considered to be the optimal conformation of the polymer region, and the score of this conformation is considered to be the optimal score. This results in the identification of a single set of coordinates for the mutated polymer structure. However, the single set of coordinates for the mutated polymer structure forms this basis for selecting a plurality of coordinates for the mutated polymer structure. In some instances, this is done by iterating over each residue i in the region of the polymer 49 and, for that residue i, cycling through each rotamer for the residue type of residue i in the side chain rotamer base while holding all other residue side chains fixed in the conformation found in the optimal conformation of the polymer region. Each unique conformation of the polymer resulting from the application of a side chain rotamer to residue i from rotamer database 52 is scored. If the difference between this score and the optimal score (e.g., the score of the optimal polymer structure that is being used to generate the plurality of structures) satisfies a threshold value (e.g., a difference between the energy of the unique conformation and optimal conformation is less than a predetermined energy cutoff), the unique conformation is added to the set of possible thermodynamically relevant alternate conformations. After all rotamers have been applied to all residues in the region 49 of the polymer, the search and optimization process terminates in step 410.

In some instances, steps 406 through 410 are coupled together as part of a refinement algorithm that is directed to finding a mutated structure 56 with lower energy. Such refinement algorithms include simulated annealing and genetic algorithms. As such, repetition of steps 406 through 410 raises the possibility of using starting coordinates that deviate substantially from those of the initial coordinates available at the end of steps 402 or 404. Moreover, by allowing a decision process in which it is possible to use a particularly well scoring structure as the starting point for a new instance of step 406, it is possible to lock in, at least temporarily, favorable rotamer conformations for one or more residues in the region of the polymer while exploring rotamer conformations for other residues in the region of the polymer on a random or pseudorandom basis.

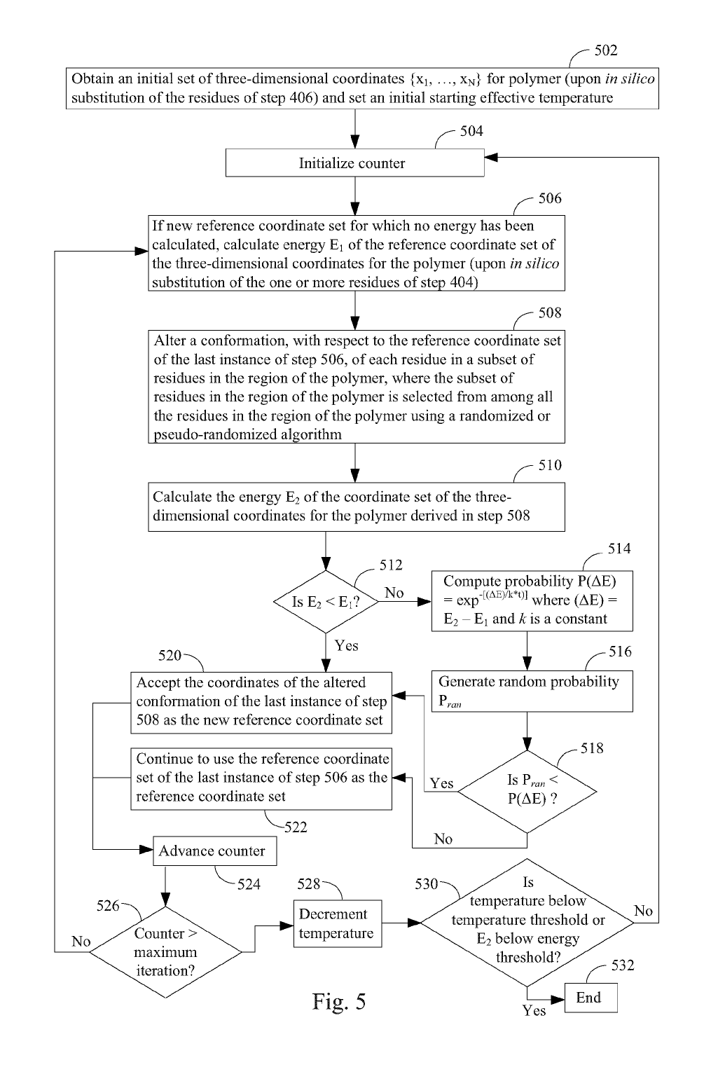

FIG. 5 illustrates one such instance of steps 406 through 410 of FIG. 4 in which mutated polymer structures, each having the primary sequence of mutated polymer 56 derived in step 404, are created in a manner where it is possible to use a structure derived in a previous instance of step 406 as the starting structure in a new instance of step 406 rather than the coordinates from step 404, under certain circumstances. In step 502, the initial set of coordinates {x₁, . . . , x_{N}} for the polymer 44, upon in silico substitution of the residues of step 406, is obtained. In the second phase of processing step 502, an initial starting temperature is chosen. The use of an initial starting temperature to obtain better heuristic solutions to a combinatorial optimization problem has its roots in the work of Kirkpatrick et al., 1983, Science 220, 4598. Kirkpatrick et al. noted the methods used to find the low-energy state of a material, in which a single crystal of the material is first melted by raising the temperature of the material. Then, the temperature of the material is slowly lowered in the vicinity of the freezing point of the material. In this way, the true low-energy state of the material, rather than some high energy-state, such as a glass, is determined. Kirkpatrick et al. noted that the methods for finding the low-energy state of a material can be applied to other combinatorial optimization problems if a proper analogy to temperature as well as an appropriate probabilistic function, which is driven by this analogy to temperature, can be developed. The art has termed the analogy to temperature an effective temperature. It will be appreciated that any effective temperature t may be chosen in processing step 502. One of skill in the art will further appreciate that the refinement of an objective function using simulated annealing is most effective when high effective temperatures are chosen. There is no requirement that the effective temperature adhere to any physical dimension such as degrees Celsius, etc. Indeed, the dimensions of the effective temperature t used in the simulated annealing schedule adopts the same units as the objective function that is the subject of the optimization.

In some instances, the starting value for the effective temperature is selected based on the amount of resources available to compute the simulated annealing schedule. In still another instance, the starting value for the effective temperature is related to the form of the probability function used in processing step 514. It has been found, in fact, that the effective temperature does not have to be very large to produce a substantial probability of keeping a worse score. Therefore, in some instances, the starting effective temperature is not large.

Once an initial set of three-dimensional coordinates {x₁, . . . , x_{N}} for a polymer (upon in silico substitution of the residues of step 406) and an initial starting effective temperature has been selected, an iterative process begins. A counter is initialized in processing step 504. In processing step 506, a score (E₁) for a scoring function, such as any of those disclosed in step 408 above, is calculated if there is a new reference coordinate set for which no score has been calculated. In the first instance of step 506, the new coordinate set is the initial set of three-dimensional coordinates {x₁, . . . x_{N}} obtained in step 502 upon in silico substitution of the residues in step 406. In subsequent instances of step 506, the identity of the new reference coordinate set is dictated by further processing steps as disclosed below.

After a score (E₁) of the new reference coordinate set has been determined in step 506, process control passes to step 508 in which a conformation, with respect to the reference coordinate set of step 506, of each residue in a subset of residues in the region of the polymer is altered. The subset of residues in the region of the polymer is selected from among all the residues in the region of the polymer using a deterministic, randomized or pseudo-randomized algorithm. In some instances, this algorithm is a Monte Carlo algorithm. Then, in step 510, a score (E₂) of the coordinate set of the three-dimensional coordinates for the polymer derived in the last instance of step 508 is calculated using the scoring function that was used to score the initial coordinate set. When the score of the coordinate set derived in step 508 is less than that of the reference coordinate set of step 506 (E₂<E₁) (512—Yes), the coordinates derived in the last instance of step 508 are used as the new reference coordinate set (520). Otherwise (512—No), the coordinates derived in the last instance of step 508 is accepted as the new reference coordinate set with some probability, such as exp^{-[(ΔE)/k*T)]}. In some instances, such as when the probability is exp^{-[(ΔE)/k*T)]}, the probability that the coordinates derived in the last instance of step 508 is accepted as the new reference coordinate set, when (E₂>E₁), is lower at lower effective temperatures. Use of the exemplary probability function 1−exp^{-[(ΔE)/k*T)]} is illustrated as processing steps 514 through 522 in FIG. 5. It will be appreciated that other probability functions P(Δ) other than exp^{-[(ΔE)/k*T)]} could be used and all such functions are within the scope of the present disclosure. In processing step 514, the expression exp^{-[(ΔE)/k*T)]} is computed. In processing step 516, a number Pᵣₐₙ in the interval 0 to 1 is generated. If Pᵣₐₙ is less than P(ΔE) (518—Yes), the coordinates of the last altered conformation of the last step 508 is accepted as the new reference coordinate set. If Pᵣₐₙ is more than exp^{-[(ΔE)/k*T)]} (518—No), the reference coordinate set of the last instance of step 506 is retained as the reference coordinate set (522).

Acceptance of conditions (E₂≧E₁) for use as a new reference coordinate set on a limited probabilistic basis is advantageous because it provides the refinement system with the capability of escaping local minima traps that do not represent a global solution to the objective function. One of skill in the art will appreciate, therefore, that probability functions other than exp^{-[(ΔE)/k*T)]} will advance the goals of the present disclosure. Representative probability functions include, for example, functions that are linearly or logarithmically dependent upon effective temperature, in addition to those that are exponentially dependent on effective temperature.

In some instances, the three-dimensional coordinates for the polymer derived in the last instance of step 508 are recorded when (i) their energy E₂ has been accepted (e.g., when simulated annealing is used either because E₂ is less than E₁ or on a probabilistic basis when E₂ is greater than E₁ as set forth above) and (ii) E₂−Eₘᵢₙ<E₀, where E₀≧0 is a predetermined, but arbitrary, threshold value, and Eₘₛ, is the energy of the lowest energy accepted for a configuration of the polymer encountered up to and including the current iteration of the refinement algorithm. It will be appreciated that these conditions for recording the three-dimensional coordinates, E₂ accepted and E₂−Eₘᵢₙ<E₀ for the polymer can be used when refinement algorithms other than simulated annealing (such as genetic algorithms) are used as well.

Processing steps 506 through 522 represent one iteration in the refinement process illustrated in FIG. 5. In processing step 524 an iteration count is advanced. When the iteration count does not exceed the maximum iteration count (526—No), the process continues at 506. When the iteration count equals a maximum iteration flag (526—Yes), effective temperature t is reduced (528). One of skill in the art will appreciate that there are many different types of schedules that are used to reduce effective temperature t in various instances of processing step 528. All such schedules are within the scope of the present disclosure. In one use case, effective temperature t is reduced in step 528 by one, two, three, four, five, six, seven, eight, nine, ten, eleven, twelve, thirteen, fourteen, or fifteen percent. In another use case, effective temperature t is reduced by a constant value. For example, the effective temperature could be reduced by 50, 100, 150, 200, 250, 300, 350, 400, 450, or 500 Kelvin each time processing step 528 is executed.

When the effective temperature has been reduced by an amount in processing step 528, a check is performed to determine whether the simulated annealing schedule should be terminated (530). In the use case illustrated in FIG. 5, the process is terminated (530—Yes, 532) when effective temperature t has fallen below a low effective temperature threshold or E₂ falls below a predetermined score. In typical instances, a predetermined score for E₂ is generally not available. Generally, the algorithm runs to the specified minimum temperature, for the specified number of cycles and no termination criterion is applied to E₂. In some instances, a termination criterion is applied to E₂ that specifies termination (530—No) if the number of cycles between the present iteration of the algorithm and the last time E₂ was less than Eₘᵢₙ is greater than some threshold number of iterations c. For instance, if Eₘᵢₙ is fifteen relative energy units and c is five iterations, the process would terminate when five iterations in a row failed to achieve an E₂ that was less than Eₘᵢₙ.

The low effective temperature threshold is any suitably chosen effective temperature that allows for a sufficient number of iterations of the refinement cycle at relatively low effective temperatures. When it is determined that the annealing schedule should not end (530—No), process control passes to step 504 with the reinitialization of the counter back to a starting value so that a counter toward maximum iteration can begin again.

In another use case of the present example, a distinctly different exit condition than the one illustrated in FIG. 5 is used. In this alternative use case, a separate counter is maintained. This counter, which could be termed a stage counter, is incremented each time the effective temperature is reduced in step 528. When the stage counter has exceeded a predetermined value, such as fifty, the simulating annealing process ends (532). In yet another use case, a counter tracks a consecutive number of times the coordinate set of step 508 is rejected. When a set number of arbitrary changes in a row have been rejected, the process ends (532).

Step 412.

Returning to FIG. 4, the net result of steps 406 through 410, optionally implemented as steps 502 through 532 of FIG. 5, is a plurality of stored mutated polymer structures 56 each having the primary sequence of mutated polymer 55. In some instances, steps 406 through 410 produce one hundred or more, two hundred or more, three hundred or more, five hundred or more, one thousand or more, ten thousand or more, one hundred thousand or more or 1 million or more mutated polymer structures 56 each having the primary sequence of mutated polymer 55. In step 412, these mutated polymer structures are clustered on a residue by residue basis.

In instances where large rotamer libraries are used in steps 406 through 410, or the steps operate in continuous space (e.g., continuum space Monte Carlo), a very large number of mutated polymer structures in which there are only slightly different configurations with slightly different energies will be generated. One could sum over all of these structures and derive thermodynamic properties out of the structures. However, the objective is to assist in understanding structurally the effects of the mutations of step 404. So, the set of mutated polymer structures 56 is reduced in step 412 to a set of meaningfully distinct structural conformations. For instance, consider the case in which there are two mutated polymer structures 56 that only differ by half a degree in a single terminal dihedral angle. Such structures are not deemed to be meaningfully distinct and therefore fall into the same cluster in some instances of the present disclosure.

Advantageously, the example provides for reducing the plurality of mutated polymer structures 56 into a reduced set of structures without losing information about meaningfully distinct conformations found in the plurality of mutated polymer structures 56. This is done in some use case by clustering on side chains individually and the backbone individually (e.g., on a residue by residue basis). This is done in other use cases by (i) clustering on side chains individually and (ii) separately clustering based on a structural metric associated with the main chain of each contiguous block of main chains in the plurality of structures, thereby deriving a set of main chain clusters for each contiguous block of main chain coordinates. Regardless of which use case is performed, if there is a meaningful shift in any side chain or any backbone between two of the mutated polymer structures 56, even if the two structures are otherwise structurally very similar, the clustering ultimately will not group the two conformations into the same cluster and thus obscure that difference. In some instances, the residue by residue clustering imposes a root-mean-square distance (RMSD) cutoff on the coordinates of the subject side chain atoms or the subject main chain atoms. For example, when clustering on a particular residue side chain, two mutated polymer structures 56 will fall into the same cluster for the particular residue side chain when the RMSD between the side chain atoms of the particular side chain in the two mutated polymer structures 56 falls below a predetermined RMSD cutoff value. This RMSD is computed between the side chain of the particular residue after the two mutated polymer structures 56 have been superimposed upon each other using conventional techniques.

Another way of considering the novel approach taken in step 412 is to consider the samplings made in steps 406 through 410 that are made in rotameric space, and consider that the outcome of steps 406 through 410 is that, for each residue in the sequence of the mutated polymer, there is now a list of possible rotamers. If a sufficient number of rotamers is sampled, this list becomes very large for each residue and, in fact, if continuum space is considered, this list can approach infinity for each residue. Thus, in step 412, particularly in the case where continuum space or a large rotamer library is used in steps 406 through 410, what is obtained is the definition of a new rotamer library for each residue; not by residue type but for each residue in the sequence of the mutated polymer 55, where each cluster for each residue is a new rotamer. This can be done for the backbone or some segment of the backbone as well.

Thus, step 412 clusters based on change in conformation, change in RMSD or change in angles, without considering the score of the mutated polymer structures 56. In this way, either the backbone or the side chain of a given residue of a mutated polymer structure 56 could trigger an event in which that conformation together, the backbone and side chain, just simply cannot go into the same cluster as another mutated polymer structure 56.

In some instances, the type of clustering that is performed in step 414 on a residue by residue basis, and on each side chain individually and on each main chain individually is maximal linkage agglomerative clustering.

Clustering is described on pages 211-256 of Duda and Hart, Pattern Classification and Scene Analysis, 1973, John Wiley & Sons, Inc., New York, (hereinafter “Duda 1973”) which is hereby incorporated by reference in its entirety. As described in Section 6.7 of Duda 1973, the clustering problem is described as one of finding natural groupings in a dataset. To identify natural groupings, two issues are addressed. First, a way to measure similarity (or dissimilarity) between two samples is determined. This metric (similarity measure) is used to ensure that the samples in one cluster are more like one another than they are to samples in other clusters. Second, a mechanism for partitioning the data into clusters using the similarity measure is determined.

Similarity measures are discussed in Section 6.7 of Duda 1973, where it is stated that one way to begin a clustering investigation is to define a distance function and to compute the matrix of distances between all pairs of samples in a dataset. If distance is a good measure of similarity, then the distance between samples in the same cluster will be significantly less than the distance between samples in different clusters. However, as stated on page 215 of Duda 1973, clustering does not require the use of a distance metric. For example, a nonmetric similarity function s(x, x′) can be used to compare two vectors x and x′. Conventionally, s(x, x′) is a symmetric function whose value is large when x and x′ are somehow “similar”. An example of a nonmetric similarity function s(x, x′) is provided on page 216 of Duda 1973.

Once a method for measuring “similarity” or “dissimilarity” between points in a dataset has been selected, clustering requires a criterion function that measures the clustering quality of any partition of the data. Partitions of the data set that extremize the criterion function are used to cluster the data. See page 217 of Duda 1973. Criterion functions are discussed in Section 6.8 of Duda 1973.

More recently, Duda et al., Pattern Classification, 2^{nd} edition, John Wiley & Sons, Inc. New York, has been published. Pages 537-563 of the reference describe clustering in detail. More information on clustering techniques can be found in Kaufman and Rousseeuw, 1990, Finding Groups in Data: An Introduction to Cluster Analysis, Wiley, New York, N.Y.; Everitt, 1993, Cluster analysis (3d ed.), Wiley, New York, N.Y.; and Backer, 1995, Computer Assisted Reasoning in Cluster Analysis, Prentice Hall, Upper Saddle River, N.J. Particular exemplary clustering techniques that can be used in step 414 include, but are not limited to, hierarchical clustering (agglomerative clustering using nearest-neighbor algorithm, farthest-neighbor algorithm, the average linkage algorithm, the centroid algorithm, or the sum-of-squares algorithm), k-means clustering, fuzzy k-means clustering algorithm, Jarvis-Patrick clustering, and steepest-descent clustering.

In some instances in step 414, the plurality of mutated polymer structures 56 are clustered based on the conformation of residue 1 of the mutated polymer 55 in each of the mutated polymer structures 56 to form a first set of clusters. Next, the plurality of mutated polymer structures 56 are separately clustered based on the conformation of residue 2 of the mutated polymer 55 in each of the mutated polymer structures 56 to form a second set of clusters, and so forth to form a set of clusters for each residue in the mutated polymer.

In some instances, the plurality of mutated polymer structures 56 is clustered on a residue by residue basis for side chain conformation only. That is, the plurality of mutated polymer structures 56 are clustered based on the conformation of the side chains of residue 1 of the mutated polymer 55 in each of the mutated polymer structures 56 to form a first set of clusters. Next, the plurality of mutated polymer structures 56 are clustered based on the conformation of the side chains of residue 2 of the mutated polymer 55 in each of the mutated polymer structures 56 to form a second set of clusters, and so forth to form a set of clusters for each residue in the mutated polymer where the conformation of the main chain atoms of the polymer did not inform or affect the clustering.

In some instances, the plurality of mutated polymer structures 56 are clustered on a residue by residue basis for side chain conformation and, separately, on a residue by residue basis for main chain conformation. That is, the plurality of mutated polymer structures 56 are clustered based on the conformation of the side chains of residue 1 of the mutated polymer 55 in each of the mutated polymer structures 56 to form a first set of clusters. Next, the plurality of mutated polymer structures 56 are clustered based on the conformation of the main chains of residue 1 of the mutated polymer 55 in each of the mutated polymer structures 56 to form a second set of clusters. Next, the plurality of mutated polymer structures 56 are clustered based on the conformation of the side chains of residue 2 of the mutated polymer 55 in each of the mutated polymer structures 56 to form a third set of clusters. Next, the plurality of mutated polymer structures 56 are clustered based on the conformation of the main chains of residue 2 of the mutated polymer 55 in each of the mutated polymer structures 56 to form a fourth set of clusters, and so forth to form two sets of clusters for each residue in the mutated polymer, a main chain set for each residue and a side chain set for each residue.

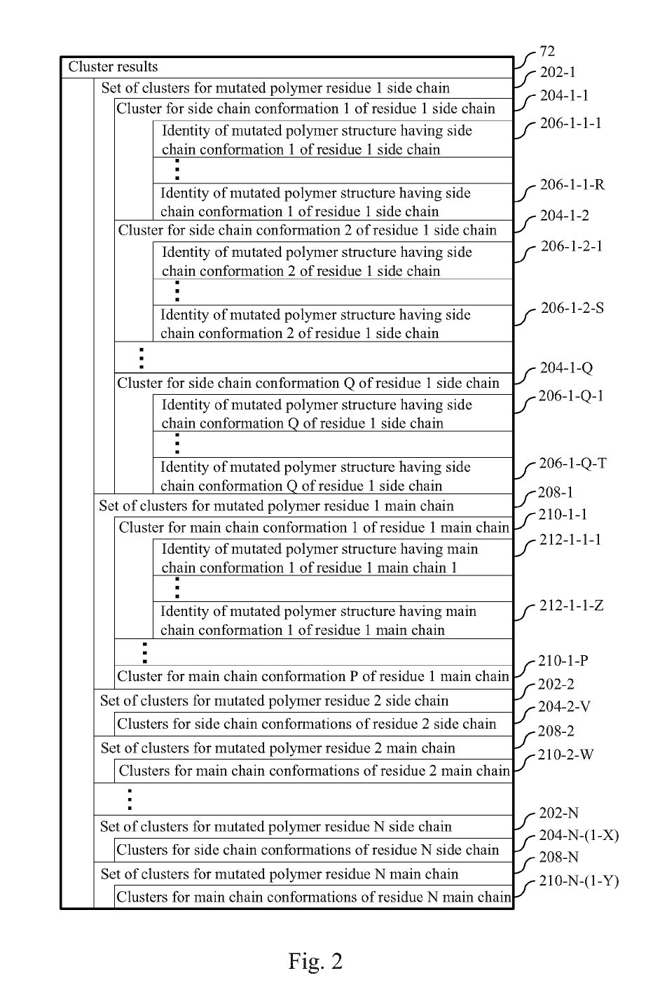

FIG. 2 illustrates the cluster results 72 that are obtained in this use case. For each respective residue in the sequence of the mutated polymer 55, there is a set of clusters 202 for the side chain of the respective residue and a set of clusters 208 for the main chain of the respective residue. Each set of clusters 202 includes one or more clusters 204. Each cluster 204 includes the identity of one or more mutated polymer structures 206 that fall into the cluster. Each set of clusters 208 includes one or more clusters 210. Each cluster 210 includes the identity of one or more mutated polymer structures 206 that fall into the cluster. In alternative instances, all main chain coordinates are clustered on contiguous blocks of residues. For instance, consider the case in which the polymer comprises an “A” domain and a “B” domain, where the main chain is not contiguous between the “A” domain and the “B” domain and residues in the A domain are designated A/XX whereas residues in the B domain are designated B/XX. If residues A/100-A/110 and residues A/200-A/210 are under consideration (e.g., residues A/100-A/110 and A/200-A/210 constitute the region of the polymer under consideration), all side chain degrees of freedom are clustered and then all the main chain degrees of freedom for residues A/100-A/110 are clustered as a unit, and all main chain degrees of freedom for residues A/200-A/210 are clustered as a unit.

Advantageously, the threshold used for clustering is determined through the automated training process making use of manual review disclosed in FIG. 8. In some instances, the measure of structural distinctiveness is quantified as a root-mean-square deviation (RMSD) between the Cartesian coordinates of the heavy atoms in a residue. In some instances the measure of structural distinctiveness is the RMSD between the dihedral angles in a residue. In some instances the measure of structural distinctiveness is a metric that comprises a mathematical combination of (i) the RMSD between the dihedral angles in a residue and (ii) the RMSD between the dihedral angles in a residue.

Step 414.

The result of step 412 is that each residue in each mutated polymer structure 56 is assigned to a cluster group. In typical use cases, the side chain of each residue in each mutated polymer structure 56 is assigned to a side chain cluster group and the main chain of each residue in each mutated polymer structure 56 is assigned to a main chain cluster group. In step 414, mutated polymer structures 56 in the plurality of mutated polymer structures generated in steps 406 through 410 are grouped together into a plurality of subgroups based on the identity of the clusters that their residues fall into.

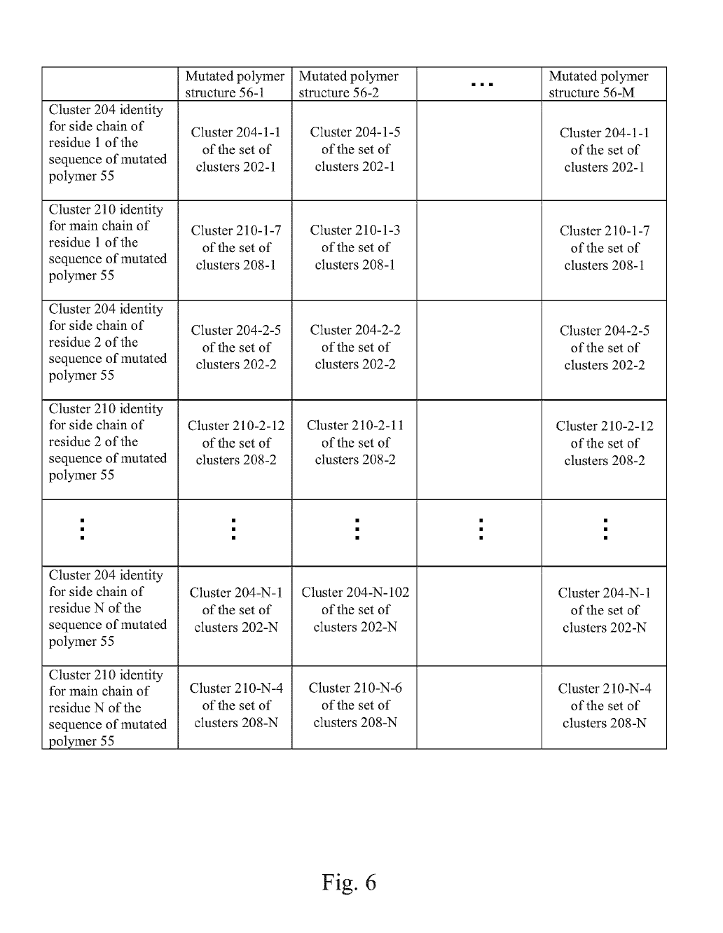

FIG. 6 illustrates the concept of step 414. Mutated polymer structure 56-1 consists of residues 1 through N. For each respective residue in each respective mutated polymer structure, there is an identity of the side chain cluster that the respective residue falls into and, optionally, an identity of the main chain cluster that the respective residue falls into. For example, the side chain of residue 1 of the mutated polymer structure 56-1 falls into cluster 204-1-1 in the set of clusters 202-1, the main chain of residue 1 of the mutated polymer structure 56-1 falls into cluster 210-1-7 in the set of clusters 208-1, the side chain of residue 2 of the mutated polymer structure 56-1 falls into cluster 204-2-5 in the set of clusters 202-2, the main chain of residue 2 of the mutated polymer structure 56-1 falls into cluster 210-2-12 in the set of clusters 208-2, and so forth.

Examination of FIG. 6 shows that mutated polymer structures 56-1 and 56-M always fall into the same cluster (204-1-1, 210-1-7, 204-2-5, 210-2-12, . . . , 204-N-1, and 210-N-4) whereas mutated polymer structure 56-2 falls into different clusters (204-1-5, 210-1-3, 204-2-2, 210-2-11, . . . , 204-N-102, and 210-N-6). Thus, in step 414, mutated polymer structures 56-1 and 56-M will be grouped into the same subgroup whereas mutated polymer structure 56-2 will be grouped into a different subgroup.

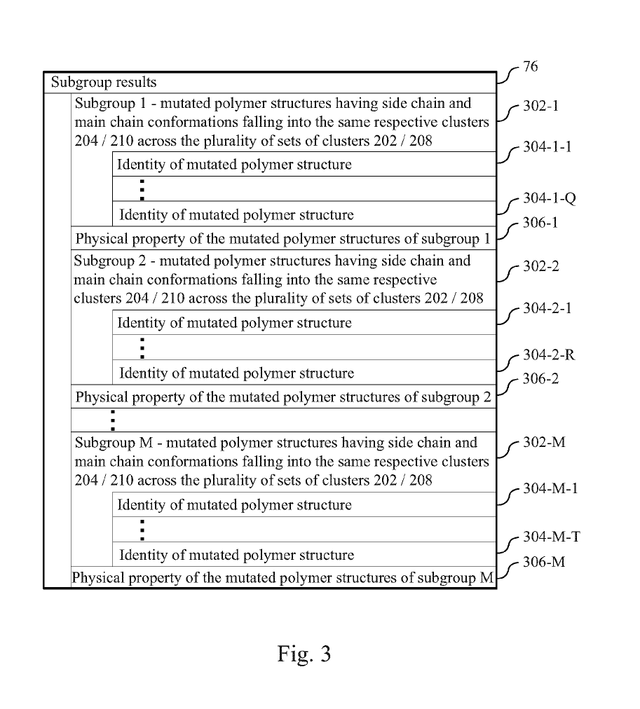

FIG. 3 illustrates the end result of processing step 414. There is some number of subgroups 302. For each subgroup 302, there is a list of mutated polymer structures 55 having respective side chain and main chain conformations falling into the same respective clusters 204/201 across the plurality of sets of clusters 202/208 that were created in step 412.

In some instances, respective mutated polymer structures 56 in the plurality of mutated polymer structures are subgrouped into a plurality of subgroups 302, where each mutated polymer structure 56 in a subgroup 302 in the plurality of subgroups falls into the same cluster 204/210 in a threshold number of the sets of clusters 202/208 in the plurality of sets of clusters generated in step 412. In some instances, the threshold number of the sets of clusters 202/208 is all the sets of clusters in the plurality of sets of clusters generated in step 412. In some instances, the threshold number of the sets of clusters 202/208 is all but one, all but two, all but three, all but four, all but five, all but six, all but seven, all but eight, all but nine, or all but ten of the sets of clusters 202/208 in the plurality of sets of clusters generated in step 412. In some instances, the threshold number of the sets of clusters 202/208 is at least sixty-five percent, at least seventy percent, at least seventy-five percent, at least eighty percent, at least eighty-five percent, at least ninety percent, at least ninety-five percent, at least ninety-seven percent, at least ninety-eight percent or at least ninety-nine percent of the sets of clusters 202/208 in the plurality of sets of clusters generated in step 412. In some instances the sets of clusters 202/208 used to create a subgroup 302 is determined on the basis of a property of the polymer with its wildtype or mutated sequence. For example clusters 202/208 used to create subgroups 302 can be selected on the basis of residue type, on the basis of solvent accessible surface area in the wildtype sequence and configuration, on the basis of residue charge, on the basis of distance from the residue affected by step 404 of FIG. 4, etc.

In some instances, the mutated polymer structures 56 are classified into subgroups 76 solely on the basis of how many of their residues fall into the same side chain clusters 204 and main chain clusters 210 are not used to classify mutated polymer structures into subgroups 76. In some instances, the mutated polymer structures 56 are classified into subgroups 76 on the combined basis of how many of their residues fall into the same side chain clusters 204 and home many of their residues fall into the same main chain clusters 210.

Step 416.

In step 414, a plurality of subgroups 302 were generated. Each subgroup 302 includes a plurality of mutated polymer structures having the same mutated polymer sequence 55 and similar, but not identical structural conformations. However, typically, each mutated polymer structure in a subgroup 302 will have a different score because, while the conformations within a subgroup 302 are similar, they are not exactly the same.

Because each subgroup 302 comprises several structures rather than just a structure having a minimum score, a partition function can be computed for the structural state represented by a given subgroup 302 and used to determine thermodynamics of the conformation state represented by the given subgroup 302. For instance, a free energy estimate can be computed for the general structural conformation represented by each subgroup 302 in the plurality of subgroups.

In some instances, an average is taken over all the structural conformations of the mutated polymer structures mapping into a subgroup 302 and one or more properties of the mutated polymer structures is determined as well as a range for each of the one or more properties. Here, the average can be the arithmetic average, or a thermodynamic average. In some instances, the property is a mean distance between two things within the polymer structure, mean distance between a point in the polymer structure and a point on a receptor that the polymer structure binds, etc. It will be appreciated that a property in the one or more properties does not have to be a simple a mean. Examples of properties that may be ascertained also include median properties, or properties such as an entropy or variance in structural quantity, to name a few.

In some instances, a filter is applied such that subgroups 302 having an average energy that is above a threshold energy are eliminated. In some instances, a filter is applied such that subgroups 302 having less than a threshold number for polymer structures are eliminated. However, in some instances, even subgroups 302 having fewer than a threshold number of polymer structures are retained when the average energy for such subgroups is sufficiently low. In some instances, a subgroup having a low average energy is used as the starting basis for another iteration of steps 406 through 416.

In some instances an accessible surface area is computed for an ensemble of structures in a subgroup 302, where the ensemble of structures is treated as a single structure. The accessible surface area (ASA), also known as the “accessible surface”, is the surface area of a biomolecule that is accessible to a solvent. Measurement of ASA is usually described in units of square Angstroms. ASA is described in Lee & Richards, 1971, J. Mol. Biol. 55(3), 379-400, which is hereby incorporated by reference herein in its entirety. ASA can be calculated, for example, using the “rolling ball” algorithm developed by Shrake & Rupley, 1973, J. Mol. Biol. 79(2): 351-371, which is hereby incorporated by reference herein in its entirety. This algorithm uses a sphere (of solvent) of a particular radius to “probe” the surface of the molecule.

In some instances a solvent-excluded surface is computed for an ensemble of structures in a subgroup 302, where the ensemble of structures is treated as a single structure. The solvent-excluded surface, also known as the molecular surface or Connolly surface, can be viewed as a cavity in bulk solvent (effectively the inverse of the solvent-accessible surface). It can be calculated in practice via a rolling-ball algorithm developed by Richards, 1977, Annu Rev Biophys Bioeng 6, 151-176 and implemented three-dimensionally by Connolly, 1992, J. Mol. Graphics 11(2), 139-141, each of which is hereby incorporated by reference herein in its entirety.

In some instances, a physical property that is determined in step 416 is a presence or mean energy of a covalent bond or hydrogen bond between a first atom and a second atom in the ensemble of structures in a subgroup 302. Hydrogen bonds are formed when an electronegative atom approaches a hydrogen atom bound to another electro-negative atom. The most common electronegative atoms in biochemical systems are oxygen (3.44) and nitrogen (3.04) while carbon (2.55) and hydrogen (2.22) are relatively electropositive. The hydrogen is normally covalently attached to one atom, the donor, but interacts electrostatically with the other, the acceptor. This interaction is due to the dipole between the electronegative atoms and the proton. Thus, the first atom in the plurality of atoms represented by particle pᵢ is the donor and the second atom in the plurality of atoms represented by particle pⱼ is the acceptor of the hydrogen, or vice versa. Moreover, the first atom in the plurality of atoms represented by particle pᵢ and the second atom in the plurality of atoms represented by particle pⱼ share the same hydrogen. The occurrence of hydrogen bonds in protein structures has been extensively reviewed by Baker & Hubbard, 1984, Prog. Biophy. Mol. Biol., 44, 97-179, which is hereby incorporated by reference herein in its entirety.

In some instances, a physical property that is determined in step 416 is a presence or mean energy of a carbon-carbon contact, a carbon-sulfur contact, or a sulfur-sulfur contact between a first atom and a second atom in the ensemble of structures in a subgroup 302. In some instances, a carbon-carbon contact, a carbon-sulfur contact, or a sulfur-sulfur contact occurs when the first atom and the second atom are each independently carbon or sulfur and the first atom and the second atom are within a predetermined distance of each other in the complex molecule. In some instances, this predetermined distance is 4.5 Angstroms. In some instances, this predetermined distance is 4.0 Angstroms.

In some instances, a physical property that is determined in step 416 is a presence or mean energy of a carbon-nitrogen contact between a first atom and a second atom in the ensemble of structures in a subgroup 302. In some instances, a carbon-nitrogen contact occurs when the first atom is a carbon and the second atom is a nitrogen and the first atom and the second atom are within a predetermined distance of each other in the complex molecule as defined by the three-dimensional coordinates {x₁, . . . , x_{N}}. In some instances, this predetermined distance is 4.5 Angstroms. In some instances, this predetermined distance is 4.0 Angstroms. In some instances, this predetermined distance is 3.5 Angstroms.

In some instances, a physical property that is determined in step 416 is a presence or mean energy of a carbon-oxygen contact between a first atom and a second atom in the ensemble of structures in a subgroup 302. In some instances, a carbon-oxygen contact occurs when the first atom is a carbon and the second atom is a oxygen and the first atom and the second atom are within a predetermined distance of each other in the complex molecule. In some instances, this predetermined distance is 4.5 Angstroms. In some instances, this predetermined distance is 4.0 Angstroms. In some instances, this predetermined distance is 3.5 Angstroms.

In some instances, a physical property that is determined in step 416 is a presence of or mean energy of a π-π interaction or a π-cation interaction between a first atom and a second atom in the ensemble of structures in a subgroup 302. A π-π interaction is an attractive, noncovalent interaction between aromatic rings in which the aromatic rings are parallel to each other or form a T-shaped configuration and their respective centers of mass are approximately five Angstroms apart. See, for example, Brocchieri and Karlin, 1994, PNAS 91:20, 9297-9301, which is hereby incorporated by reference. A π-cation interaction is a noncovalent molecular interaction between the face of an electron-rich π system (e.g. benzene, ethylene) and an adjacent cation (e.g. NH₃ group of lysine, the guanidine group of arginine, etc.). This interaction is an example of noncovalent bonding between a quadrupole Or system) and a monopole (cation).

In some instances, a physical property that is determined in step 416 is a measure of structural diversity within each subgroup. An example of a measure of structural diversity is the configurational entropy computed from the partition function created by summing over all members of a subgroup.

### Example 2

This example demonstrates the ability of the invention to identify thermodynamically relevant alternate conformations of a protein. The example makes use of an antibody Fc structure (PDB Accession ID 1E4K), herein referred to as the wild type structure. A mutated polymer structure 56 was prepared by mutating residues B/248.LYS, B/249.ASP, B/250.THR in the parent structure to GLY, ARG, and GLY respectively. A region 49 of the muted polymer structure 56 was then defined by enumerating every residue that had a heavy atom with a distance less than 8 Å from any heavy atom of residues B/248-250 in the wild type structure. A random conformation from the rotamer database 52 was subsequently assigned to each of the residues B/248-250 in the mutated polymer structure 56. For this example, the rotamer database 52 comprised the rotamers described in Xiang, 2001, “Extending the Accuracy Limits of Prediction for Side-chain Conformations,” Journal of Molecular Biology 311, p. 421, which is hereby incorporated by reference in its entirety. This rotamer library was expanded by adding the rotameric conformation observed in the wild type structure of every residue in polymer region 49.

One of the residues in region 49 of the mutated polymer was randomly selected and a rotamer in the rotamer database 52 for the side chain type at the selected residue was applied to the initial mutated polymer structure 56 prepared as described above. The main chain coordinates of the selected residue position were held fixed during application of the rotamer to the selected residue. This application of the rotamer resulted in the alteration of the side chain coordinates for the selected residue in the initial mutated polymer structure 56 and thus a new conformation in the region 49 of the polymer. In the process of applying the rotamer to the selected residue position, the conformations of the other residues in the region 49 of the mutated polymer structure were held fixed. The application of the n rotamers to n corresponding instance of the initial mutated polymer structure 56 resulted in n different structures of the polymer, where n is a positive integer, each different structure representing a different rotamer for the selected residue. The n structures of the polymer were evaluated to determine which had the lowest energy in accordance with step 408. For this energy calculation, the AMBER all-atom potential was used to score the conformations of the optimization region of each of the n structures in the manner disclosed in Ponder and Case, 2003, “Force fields for protein simulations,” Adv. Prot. Chem. 66, p. 27, which is hereby incorporated by reference herein in its entirety. The structure of the polymer that had the lowest energy was then used as the starting point for evaluating the rotamers of another residue in the set of residues comprising the polymer region 49 in the same manner as the first residue, thereby identifying a structure of the polymer that had the lowest energy when the rotamers of database 52 for the second residue selected from the set of residues comprising the polymer region 49 were polled in like manner. Once all residues in the polymer region were optimized in this manner, a new random ordering of the residues in the set was generated, and the rotamer search procedure describe above repeated using the final structure for the polymer from the last round (the structure in which the rotamer of the final residue in the set of residues in polymer region 49 has been polled to find the lowest energetic structure). The sequential optimization of rotamers in the set of residues in polymer region 49 terminated when re-optimization of all residues in the polymer region in the sequential iterative manner described above using the side chain rotamer database 52 did not result in a change in the conformation of any side chain. The last conformation of the polymer region was deemed to be the optimal conformation of the polymer region, and the score of this conformation was considered to be the optimal score. This resulted in the identification of a single set of coordinates for the mutated polymer structure.

The above procedure was employed a total of twenty times, with each use of the procedure differing by the random conformations initially assigned to residues B/248-B/250 in the starting structure. Each of the twenty instances yielded a final structure. Each of the final structures was used as a basis to generate additional structures by iterating over each residue i in the set of residues in polymer region 49 and, for that residue i, cycling through each rotamer for the residue type of residue i in the side chain rotamer database 52 while holding all other residue side chains fixed in the conformation found in the optimal conformation of the region 49 of the polymer. Each unique conformation of the polymer resulting from the application of a side chain rotamer to residue i was scored against the corresponding final structure in the twenty instances of the final structure. If the difference between this score and the optimal score satisfied a threshold value, the unique conformation was added to the set of possible thermodynamically relevant alternate conformations.

The conformations of the optimization region 49 produced as described above were then combined to form an aggregate set of alternate conformations. The scores of the optimal conformations produced by the twenty instances of the optimization procedure were compared, and the conformation with the most favorable score was accepted as the most favorable conformation of polymer region 49. It will be appreciated that, because portions of the polymer outside of the region 49 of the polymer are held fixed in this example, structural examination of the region 49 of the polymer is all that is necessary in some steps of the example, such as the clustering described below. The elements of the set of alternate conformations were then clustered and grouped in accordance with step 412. In the clustering step, complete linkage hierarchical clustering was employed, with the root-mean square deviation of the Cartesian coordinates of side chain heavy atoms serving as the distance function. See Izenman, 2008, “Modern Multivariate Statistical Techniques,”Springer Science+Business Media LLC, New York N.Y., which is hereby incorporated by reference for its teachings on complete linkage hierarchical clustering.

The distance threshold used in the clustering was set by the interactive technique disclosed above in conjunction with FIGS. 7 and 9. Specifically the technique was used to by seven individuals, each having expertise in one or more of X-ray crystallography, protein nuclear magnetic resonance, or structural biology. Each expert utilized the systems and methods of the present disclosure in order to derive a threshold value of the heavy atom RMSD required for two side chain conformations to be considered meaningfully structurally distinct. In the use of the systems and methods of the present disclosure by the experts, each repeat of step 904 displayed two conformations of an amino acid of a single type, differing only in the values of the side chain dihedral angles. The conformations were structurally aligned on the backbone heavy atoms, and were displayed in an overlaid fashion. In step 906, the expert indicated if the displayed pair of amino acid conformations was or was not a member of the class of meaningfully structurally distinct pairs of amino acid side chain conformations. In steps 910 and 912, the heavy atom side chain RMSD between the amino acid conformations was adjusted by taking the absolute value of a number selected at random from a Gaussian distribution. The sign of this value was made positive if step 910 was performed, and negative if step 912 was performed. The Gaussian distribution used had a mean of 0.1 and a standard deviation of 0.02. The pair of rotamers with a side chain RMSD closest to the RMSD value produced after completing step 910 or 912, was then selected from a rotamer library. One of the rotamers of the pair was applied to the first of the displayed structures, and the other was applied to the second displayed structure. In the use of the systems and methods of the present disclosure by the experts, the value of M was set to 10 and the value of N was set to 10. In step 919, the mean of the side chain heavy atom RMSD values used in the final N repetitions of step 904 was computed.

Each expert used the systems and methods of the present disclosure to derive a unique threshold value of side chain heavy atom RMSD for each of the 20 standard amino acids, resulting in a set of seven threshold values for each amino acid type. The threshold value used to cluster conformations of an amino acid of a particular type was the mean of the seven values produced for that amino acid type by the experts.

Two structurally distinct thermodynamically relevant alternative conformations of the protein were identified after clustering. One alternate conformation involved a difference in the side chain position of B/252.MET relative to the conformation of this residue in the optimal conformation, and had an energy only 0.45 kcal/mol greater than the optimal conformation. The other alternate exhibited a distinct conformation of B/313.TRP, while having an energy of only 0.61 kcal/mol greater than the optimal conformation.

### CONCLUSION

The methods illustrated in FIGS. 4A, 4B, 5, 8 and 9 may be governed by instructions that are stored in a computer readable storage medium and that are executed by at least one processor of at least one server. Each of the operations shown in FIGS. 4A, 4B, 5 and 9 may correspond to instructions stored in a non-transitory computer memory or computer readable storage medium. In various implementations, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A computer-implemented method, comprising:
at a computer system having one or more processors, memory and a display;
(A) obtaining a value for a physical parameter associated with a molecular system;
(B) communicating one or more three-dimensional structures for the molecular system that exhibit the value for the physical parameter;
(C) receiving, responsive to the communicating, a dichotomous classification of the one or more three-dimensional structures, the dichotomous classification being either (i) a first indication, the first indication being that the one or more three-dimensional structures are deemed by a first user to be in a first dichotomous structural class with respect to the physical parameter or (ii) a second indication, the second indication being that the one or more three-dimensional structures are deemed by the first user to be in a second dichotomous structural class, distinct from the first dichotomous structural class, with respect to the physical parameter;
(D) altering the value for the physical parameter as a function of the dichotomous classification; and
(E) repeating the communicating (B), receiving (C), and altering (D) until an exit condition is deemed to exist.

2. The computer-implemented method of claim 1, wherein
the molecular system is a protein or protein complex,
the physical parameter is a dihedral angle of a predetermined side chain in the molecular system,
the one or more three-dimensional structures is a plurality of three-dimensional structures for the molecular system,
a first structure in the plurality of three-dimensional structures adopts a first dihedral angle for the predetermined side chain,
a second structure in the plurality of three-dimensional structures adopts a second dihedral angle for the predetermined side chain, and
the first dihedral angle and the second dihedral angle differ from each other by the value for the physical parameter.

3. The computer-implemented method of claim 2, wherein the first dihedral angle is obtained from a rotamer library.

4. The computer-implemented method of claim 2, wherein the first dihedral angle is obtained from a rotamer library on a deterministic, random or pseudo-random basis.

5. The computer-implemented method of claim 1, wherein
the one or more three-dimensional structures is a plurality of three-dimensional structures,
the physical parameter is the root mean squared distance between a side chain of a first residue in a first three-dimensional structure in the plurality of three-dimensional structures and the side chain of the first residue in a second three-dimensional structure in the plurality of three-dimensional structures when the first and second three-dimensional structures are aligned on the coordinates of the backbone atoms and the first three-dimensional structure is overlayed on the second three-dimensional structure.

6. The computer-implemented method of claim 1, wherein
the one or more three-dimensional structures is a plurality of three-dimensional structures,
the physical parameter is the root mean squared distance between heavy atoms in a first portion of a first three-dimensional structure in the plurality of three-dimensional structures and the corresponding heavy atoms in the portion of a second three-dimensional structure in the plurality of three-dimensional structures corresponding to the first portion when the first three-dimensional structure is overlayed on the second three-dimensional structure.

7. The computer-implemented method of claim 1, wherein
the one or more three-dimensional structures comprises a plurality of three-dimensional structures,
the dichotomous classification received in the receiving (C) is the first indication when each member of the plurality of three-dimensional structures is deemed by the first user to be structurally distinct with respect to all other members of the plurality of three-dimensional structures with respect to the physical parameter, and
the dichotomous classification received in the receiving (C) is the second indication when any member of the plurality of three-dimensional structures is deemed by the first user to be structurally indistinct with respect to any other members of the plurality of three-dimensional structures with respect to the physical parameter.

8. The computer-implemented method of claim 1 wherein the one or more three-dimensional structures consists of a single three-dimensional structure.

9. The computer-implemented method of claim 8, wherein
the physical parameter is an interatomic distance between a first atom and a second atom of the molecular system and the value for the physical parameter is a distance between the first atom and the second atom in the molecular system.

10. The computer-implement method of claim 8, wherein the physical parameter is the existence of at least one steric clash, the value for the physical parameter is an interatomic distance, and
the dichotomous classification received in the receiving (C) is the first indication when the single three-dimensional structure is deemed by the first user to exhibit at least one steric clash, and
the dichotomous classification received in the receiving (C) is the second indication when the single three-dimensional structure is deemed by the first user to not exhibit at least one steric clash.

11. The computer-implemented method of claim 1, wherein
the physical parameter is a solvent accessibility, accessible surface area, or solvent-excluded surface of a portion of the molecular system,
the one or more three-dimensional structures comprises a plurality of three-dimensional structures of the molecular system,
a first three-dimensional structure in the plurality of three-dimensional structures has a first value for the physical parameter,
a second three-dimensional structure in the plurality of three-dimensional structures has a second value for the physical parameter, and
the first value deviates from the second value by the value for the physical parameter obtained in the obtaining (A) or the altering (D).

12. The computer-implemented method of claim 11, wherein
the dichotomous classification received in the receiving (C) is the first indication when the first value is deemed by the first user to be distinct from the second value with respect to the physical parameter, and
the dichotomous classification received in the receiving (C) is the second indication when the first value is deemed by the first user to not be distinct from the second value with respect to the physical parameter.

13. The computer-implemented method of claim 1, wherein the physical parameter is a solvent accessibility, accessible surface area, or solvent-excluded surface of a portion of the molecule and the one or more three-dimensional structures consists of a single structure.

14. The computer-implement method of claim 13, wherein
the dichotomous classification received in the receiving (C) is the first indication when the first user deems a predetermined portion of the molecular system to be buried in the single structure, and
the dichotomous classification received in the receiving (C) is the second indication when the first user deems the predetermined portion of the molecular system to not be buried in the single structure.

15. The computer-implemented method of any one of claims 1-14, wherein the altering (D) comprises:
increasing the value for the physical parameter, when the dichotomous classification in the previous instance of the receiving (C) is the first indication, and
decreasing the value for the physical parameter, when the dichotomous classification in the previous instance of the receiving (C) is the second indication.

16. The computer-implemented method of claim 15, wherein increasing the value for the physical parameter is accomplished by adjusting the coordinates of one or more atoms in the one or more three-dimensional structures without human intervention.

17. The computer-implemented method of claim 15, wherein increasing the value for the physical parameter is accomplished by substituting in one or more new three-dimensional structures into the one or more three-dimensional structures of the molecular system.

18. The computer-implemented method of claim 15, wherein decreasing the value for the physical parameter is accomplished by adjusting the coordinates of one or more atoms in the one or more three-dimensional structures without human intervention.

19. The computer-implemented method of claim 15, wherein decreasing the value for the physical parameter is accomplished by substituting in one or more new three-dimensional structures into the one or more three-dimensional structures of the molecular system.

20. The computer-implemented method of any one of claims 1-19, wherein the exit condition is the first of (i) achievement of a maximum repeat count or (ii) a determination that at least M repeats of steps (B) through (D) have occurred in which, in the N most recent instances of step (C), the collective number of times the received dichotomous classification is the first indication equaled the collective number of times the received dichotomous classification is the second indication, wherein M is a first predetermined positive integer, N is a second predetermined positive integer, and N is equal to or less than M.

21. The computer-implemented method of claim 20, wherein the predetermined positive integer M is set at a value of five or greater.

22. The computer-implemented method of claim 20, wherein the predetermined positive integer N is set at a value of M−1.

23. The computer-implement method of any one of claims 1-22, wherein the molecular system is a polynucleic acid, a polyribonucleic acid, a polysaccharide, or a polypeptide.

24. The computer-implement method of any one of claims 1-22, wherein the molecular system is an organometallic complex, a surfactant, or a fullerene.

25. The computer-implement method of any one of claims 1-22, wherein the molecular system is antigen-antibody complex.

26. The computer-implemented method of claim 1, wherein
the molecular system is a protein,
the physical parameter is a dihedral angle of a predetermined main chain residue in the protein,
the one or more three-dimensional structures is a plurality of three-dimensional structures,
a first structure in the plurality of three-dimensional structures adopts a first dihedral angle in the predetermined main chain,
a second structure in the plurality of three-dimensional structures adopts a second dihedral angle for the predetermined main chain,
the first dihedral angle and the second dihedral angle differ from each other by the value for the physical parameter,
the dichotomous classification received in the receiving (C) is the first indication when the first user deems the first dihedral angle and the second dihedral angle in the respective first and second structures to be structurally distinct, and
the dichotomous classification received in the receiving (C) is the second indication when the first user deems the first dihedral angle and the second dihedral angle in the respective first and second structures to be structurally indistinct.

27. The computer-implemented method of claim 26, wherein the dihedral angle is the phi angle, psi angle, or omega angle.

28. The computer-implemented method of any one of claims 1-27, wherein the physical parameter is a combination of physical parameters.

29. The computer-implemented method of any one of claims 1-28, wherein the computer-implemented method further comprises:
(G) storing, responsive to the exit condition, a value or value range for the physical parameter.

30. The computer-implemented method of claim 1, wherein the one or more three-dimensional structures consists of two structures, and wherein the two structures collectively exhibit the value for the physical parameter by differing by the value for the physical parameter.

31. The computer-implemented method of claim 1, wherein the one or more three-dimensional structures comprises a plurality of three-dimensional structures and wherein each respective three-dimensional structure in the plurality of three-dimensional structures is overlayed on a reference three-dimensional structure in the plurality of three-dimensional structures in the communicating step (B).

32. A computer system for evaluating a molecular system, the computer system comprising at least one processor and memory storing one or more computational modules for execution by the at least one processor, the one or more computational modules collectively comprising non-transitory instructions for:
(A) obtaining a value for a physical parameter associated with the molecular system;
(B) communicating one or more three-dimensional structures for the molecular system that exhibit the value for the physical parameter;
(C) receiving, responsive to the communicating, a dichotomous classification of the one or more three-dimensional structures, the dichotomous classification being either (i) a first indication, the first indication being that the one or more three-dimensional structures are deemed by a first user to be in a first dichotomous structural class with respect to the physical parameter or (ii) a second indication, the second indication being that the one or more three-dimensional structures are deemed by the first user to be in a second dichotomous structural class, distinct from the first dichotomous structural class, with respect to the physical parameter;
(D) altering the value for the physical parameter as a function of the dichotomous classification; and
(E) repeating the communicating (B), receiving (C), and altering (D) until an exit condition is deemed to exist.

33. The computer system of claim 32, wherein
the molecular system is a protein or protein complex,
the physical parameter is a dihedral angle of a predetermined side chain in the molecular system,
the one or more three-dimensional structures is a plurality of three-dimensional structures for the molecular system,
a first structure in the plurality of three-dimensional structures adopts a first dihedral angle for the predetermined side chain,
a second structure in the plurality of three-dimensional structures adopts a second dihedral angle for the predetermined side chain, and
the first dihedral angle and the second dihedral angle differ from each other by the value for the physical parameter.

34. The computer system of claim 33, wherein the first dihedral angle is obtained from a rotamer library.

35. The computer system of claim 33, wherein the first dihedral angle is obtained from a rotamer library on a deterministic, random or pseudo-random basis.

36. The computer system of claim 32, wherein
the one or more three-dimensional structures is a plurality of three-dimensional structures,
the physical parameter is the root mean squared distance between a side chain of a first residue in a first three-dimensional structure in the plurality of three-dimensional structures and the side chain of the first residue in a second three-dimensional structure in the plurality of three-dimensional structures when the first and second three-dimensional structures are aligned on the coordinates of the backbone atoms and the first three-dimensional structure is overlayed on the second three-dimensional structure.

37. The computer system of claim 32, wherein
the one or more three-dimensional structures is a plurality of three-dimensional structures,
the physical parameter is the root mean squared distance between heavy atoms in a first portion of a first three-dimensional structure in the plurality of three-dimensional structures and the corresponding heavy atoms in the portion of a second three-dimensional structure in the plurality of three-dimensional structures corresponding to the first portion when the first three-dimensional structure is overlayed on the second three-dimensional structure.

38. The computer system of claim 32, wherein
the one or more three-dimensional structures comprises a plurality of three-dimensional structures,
the dichotomous classification received in the receiving (C) is the first indication when each member of the plurality of three-dimensional structures is deemed by the first user to be structurally distinct with respect to all other members of the plurality of three-dimensional structures with respect to the physical parameter, and
the dichotomous classification received in the receiving (C) is the second indication when any member of the plurality of three-dimensional structures is deemed by the first user to be structurally indistinct with respect to any other members of the plurality of three-dimensional structures with respect to the physical parameter.

39. The computer system of claim 32 wherein the one or more three-dimensional structures consists of a single three-dimensional structure.

40. The computer system of claim 39, wherein
the physical parameter is an interatomic distance between a first atom and a second atom of the molecular system and the value for the physical parameter is a distance between the first atom and the second atom in the molecular system.

41. The computer system of claim 39, wherein the physical parameter is the existence of at least one steric clash, the value for the physical parameter is an interatomic distance, and
the dichotomous classification received in the receiving (C) is the first indication when the single three-dimensional structure is deemed by the first user to exhibit at least one steric clash, and
the dichotomous classification received in the receiving (C) is the second indication when the single three-dimensional structure is deemed by the first user to not exhibit at least one steric clash.

42. The computer system of claim 32, wherein
the physical parameter is a solvent accessibility, accessible surface area, or solvent-excluded surface of a portion of the molecular system,
the one or more three-dimensional structures comprises a plurality of three-dimensional structures of the molecular system,
a first three-dimensional structure in the plurality of three-dimensional structures has a first value for the physical parameter,
a second three-dimensional structure in the plurality of three-dimensional structures has a second value for the physical parameter, and
the first value deviates from the second value by the value obtained for the physical parameter in the obtaining (A) or the altering (D).

43. The computer system of claim 42, wherein
the dichotomous classification received in the receiving (C) is the first indication when the first value is deemed by the first user to be distinct from the second value with respect to the physical parameter, and
the dichotomous classification received in the receiving (C) is the second indication when the first value is deemed by the first user to not be distinct from the second value with respect to the physical parameter.

44. The computer system of claim 32, wherein the physical parameter is a solvent accessibility, accessible surface area, or solvent-excluded surface of a portion of the molecule and the one or more three-dimensional structures consists of a single structure.

45. The computer system of claim 44, wherein
the dichotomous classification received in the receiving (C) is the first indication when the first user deems a predetermined portion of the molecular system to be buried in the single structure, and
the dichotomous classification received in the receiving (C) is the second indication when the first user deems the predetermined portion of the molecular system to not be buried in the single structure.

46. The computer system of any one of claims 32-45, wherein the altering (D) comprises:
increasing the value for the physical parameter, when the dichotomous classification in the previous instance of the receiving (C) is the first indication, and
decreasing the value for the physical parameter, when the dichotomous classification in the previous instance of the receiving (C) is the second indication.

47. The computer system of claim 46, wherein increasing the value for the physical parameter is accomplished by adjusting the coordinates of one or more atoms in the one or more three-dimensional structures without human intervention.

48. The computer system of claim 46, wherein increasing the value for the physical parameter is accomplished by substituting in one or more new three-dimensional structures into the one or more three-dimensional structures of the molecular system.

49. The computer system of claim 46, wherein decreasing the value for the physical parameter is accomplished by adjusting the coordinates of one or more atoms in the one or more three-dimensional structures without human intervention.

50. The computer system of claim 46, wherein decreasing the value for the physical parameter is accomplished by substituting in one or more new three-dimensional structures into the one or more three-dimensional structures of the molecular system.

51. The computer system of claim 32, wherein the exit condition is the first of (i) achievement of a maximum repeat count or (ii) a determination that at least M repeats of the communicating (B) through the altering (D) have occurred in which, in the N most recent instances of the receiving (C), the collective number of times the received dichotomous classification is the first indication equaled the collective number of times the received dichotomous classification is the second indication, wherein M is a first predetermined positive integer, N is a second predetermined positive integer, and N is equal to or less than M.

52. The computer system of claim 50, wherein the predetermined positive integer M is set at a value of five or greater.

53. The computer system of claim 50, wherein the predetermined positive integer N is set at a value of M−1.

54. The computer system of claim 32, wherein the molecular system is a polynucleic acid, a polyribonucleic acid, a polysaccharide, or a polypeptide.

55. The computer system of claim 32, wherein the molecular system is an organometallic complex, a surfactant, or a fullerene.

56. The computer system of claim 32, wherein the molecular system is antigen-antibody complex.

57. The computer system of claim 32, wherein
the molecular system is a protein,
the physical parameter is a dihedral angle of a predetermined main chain residue in the protein,
the one or more three-dimensional structures is a plurality of three-dimensional structures,
a first structure in the plurality of three-dimensional structures adopts a first dihedral angle in the predetermined main chain,
a second structure in the plurality of three-dimensional structures adopts a second dihedral angle for the predetermined main chain,
the first dihedral angle and the second dihedral angle differ from each other by the value for the physical parameter,
the dichotomous classification received in the receiving (C) is the first indication when the first user deems the first dihedral angle and the second dihedral angle in the respective first and second structures to be structurally distinct, and
the dichotomous classification received in the receiving (C) is the second indication when the first user deems the first dihedral angle and the second dihedral angle in the respective first and second structures to be structurally indistinct.

58. The computer system of claim 57, wherein the dihedral angle is the phi angle, psi angle, or omega angle.

59. The computer system of any one of claims 32-58, wherein the physical parameter is a combination of physical parameters.

60. The computer system of any one of claims 32-58, wherein the one or more computational modules further collectively comprise non-transitory instructions for:
(G) storing, responsive to the exit condition, a value or value range for the physical parameter.

61. The computer system of claim 32, wherein the one or more three-dimensional structures consists of two structures, and wherein the two structures collectively exhibit the value for the physical parameter by differing by the value for the physical parameter.

62. The computer system of claim 32, wherein the one or more three-dimensional structures comprise a plurality of three-dimensional structures and wherein each respective three-dimensional structure in the plurality of three-dimensional structures is overlayed on a reference three-dimensional structure in the plurality of three-dimensional structures in the communicating step (B).

63. A non-transitory computer readable storage medium storing one or more computational modules for evaluating a molecular system, the one or more computational modules collectively comprising instructions for:
(A) obtaining a value for a physical parameter associated with the molecular system;
(B) communicating one or more three-dimensional structures for the molecular system that exhibit the value for the physical parameter;
(C) receiving, responsive to the communicating, a dichotomous classification of one or more three-dimensional structures, the dichotomous classification being either (i) a first indication, the first indication being that the one or more three-dimensional structures are deemed by a first user to be in a first dichotomous structural class with respect to the physical parameter or (ii) a second indication, the second indication being that the one or more three-dimensional structures are deemed by the first user to be in a second dichotomous structural class, distinct from the first dichotomous structural class, with respect to the physical parameter;
(D) altering the value for the physical parameter as a function of the dichotomous classification; and
(E) repeating the communicating (B), receiving (C), and altering (D) until an exit condition is deemed to exist.

64. The computer-implemented method of any one of claims 1-31, the method further comprising:
(G) storing, responsive to the exit condition, a value for the physical parameter, wherein the value is a measure of central tendency of the value used for the physical parameter across the N most recent instances of step (B).

65. The computer-implemented method of claim 64, wherein the measure of central tendency is an arithmetic mean, weighted mean, midrange, midhinge, trimean, Winsorized mean, median, or mode.

66. The computer-implemented method of any one of claims 1-31, the method further comprising:
(G) repeating the obtaining (A), communicating (B), receiving (C), altering (D) and repeating (E) for each respective user in a plurality of users until the exit condition is achieved for each user in the plurality of users; and
(H) storing, responsive to the exit condition, a value for the physical parameter, wherein the value is a measure of central tendency of the value used for the physical parameter across the N most recent instances of step (B) across each user in the plurality of users.

67. The computer-implemented method of claim 66 wherein the measure of central tendency is an arithmetic mean, weighted mean, midrange, midhinge, trimean, Winsorized mean, median, or mode.

68. The computer system of any one of claims 32-62, wherein the one or more computational modules further collectively comprising non-transitory instructions for:
(G) storing, responsive to the exit condition, a value for the physical parameter, wherein the value is a measure of central tendency of the value used for the physical parameter across the N most recent instances of step (B).

69. The computer system of claim 68, wherein the measure of central tendency is an arithmetic mean, weighted mean, midrange, midhinge, trimean, Winsorized mean, median, or mode.

70. The computer system of any one of claims 32-62, wherein the one or more computational modules further collectively comprise non-transitory instructions for:
(G) repeating the obtaining (A), communicating (B), receiving (C), altering (D) and repeating (E) for each respective user in a plurality of users until the exit condition is achieved for each user in the plurality of users; and
(H) storing, responsive to the exit condition, a value for the physical parameter, wherein the value is a measure of central tendency of the value used for the physical parameter across the N most recent instances of step (B) across each user in the plurality of users.

71. The computer system of claim 70 wherein the measure of central tendency is an arithmetic mean, weighted mean, midrange, midhinge, trimean, Winsorized mean, median, or mode.

72. The non-transitory computer readable storage medium of claim 63, wherein the exit condition is the first of (i) achievement of a maximum repeat count or (ii) a determination that at least M repeats of steps (B) through (D) have occurred in which, in the N most recent instances of step (C), the collective number of times the received dichotomous classification is the first indication equaled the collective number of times the received dichotomous classification is the second indication, wherein M is a first predetermined positive integer, N is a second predetermined positive integer, and N is equal to or less than M.
